(19) United States
(12) Patent Application Publication
(10) Pub. No.: US 2007/0073569 A1
(43) Pub. Date: Mar. 29, 2007

(54) METHOD AND SOFTWARE FOR MANAGING KITCHEN AND BATH DESIGN PROJECTS

(75) Inventors: Vipul Shah, Chicago, IL (US); James Guzdzoil, Winfield, IL (US)

Correspondence Address: Brent A. Hawkins, Wallenstein & Wagner, Ltd., 311 S. Wacker Drive, 53rd Floor, Chicago, IL, 60606, US

(73) Assignee: GLOBAL E-SOURCING, INC., Schaumburg, IL (US)

(21) Appl. No.: 11/463,808

(22) Filed: Aug. 10, 2006

Related U.S. Application Data
(60) Provisional application No. 60/707,047, filed on Aug. 10, 2005.

(51) Int. Cl. G05B 19/418

(52) U.S. Cl. 705/8

(57) ABSTRACT

Method and software for managing a construction project. The method comprises the steps of receiving a request of creating a new construction project track or opening an existing construction project track, receiving budget criteria and determining project task budget information for each project task based on the budget criteria.

### CROSS-REFERENCE TO RELATED APPLICATIONS

This application claims priority to U.S. Provisional Patent Application Ser. No. 60/707,047, filed Aug. 10, 2005.

### TECHNICAL FIELD

The present invention is generally related to a software and method for allowing one or more users access to the system to facilitate management of a construction project.

### BACKGROUND OF THE INVENTION

Kitchen and bath design projects are complex. Scalability and consistent profitability are difficult to maintain. Currently, no software exists to effectively manage a construction project. Particularly, no software exists which allows customers, designers, project managers, and showroom managers to effectively manage and oversee such projects. Current methods create more problems with achieving results efficiently and result in greater lengths for project completion and reduced profitability. Obstacles to growth and a desire to improve the existing business process are required by customers, designers, project managers, and showroom managers. All desire to improve the selling process and manage the delivery of projects with fewer problems, in less time, and with greater profitability.

It is this long-felt need that requires a solution for effective management of a construction project.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

The present invention relates to a method for managing a construction project. In one embodiment, the method comprises the steps of receiving a request of creating a new construction project track or opening an existing construction project track, receiving budget criteria and determining project task budget information for each project task based on the budget criteria.

According to one aspect of the present invention, the construction project track identifies at least one project task required to complete a construction project. The project task includes at least one of product task information and labor task information. The budget information for each project task includes at least of one of product budget information, labor budget information, markup costs, margin costs, and retail costs.

The method can further include that steps of inputting product task information criterion, determining product task information based upon product information criterion and associating an indicator with at least one of the project tasks. The indicator is at least one of construction project status, project task status, next action to be taken on a project task, and construction project contract status.

According to another aspect of the present invention, the method comprises the steps of receiving a user login representative of a user displaying a construction project track and displaying project task information for each of at least one project task, the project task being based the category identifier.

According to one aspect of the present invention, the user login is associated with a category identifier. Further, in the method, the construction project track identifies at least one project task required to complete the construction project.

The method further includes the step of inputting or displaying project task information. The project task information is at least one of a project type, vendor information, sub-contractor work procedure information, product task information, project task budget information, region information, district information, store information, project class information, contractor information, payment information, and contract information.

The method also includes the steps of placing the user login in a user group based on the category identifier and displaying anticipated project profit information.

The methods described can be embodied in a computer program stored on a computer readable media. The a computer program would include code segments or routines to enable all of the functional aspects of the interface described or shown herein.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of a computer used in connection with the present invention;

FIG. 2 through FIG. 2AX are illustrations of a plurality of user interfaces for use with the present invention;

FIG. 3 is an illustration of a flowchart for a system and method for managing kitchen and bath design projects; and,

FIG. 4 is a second illustration of a flowchart for a system and method for managing kitchen and bath design projects.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Process descriptions or blocks in figures should be understood as representing modules, segments, or portions of code which include one or more executable instructions for implementing specific logical functions or steps in the process. Alternate implementations are included within the scope of the embodiments of the present invention in which functions may be executed out of order from that shown or discussed, including substantially concurrently or in reverse order, depending on the functionality involved, as would be understood by those having ordinary skill in the art.

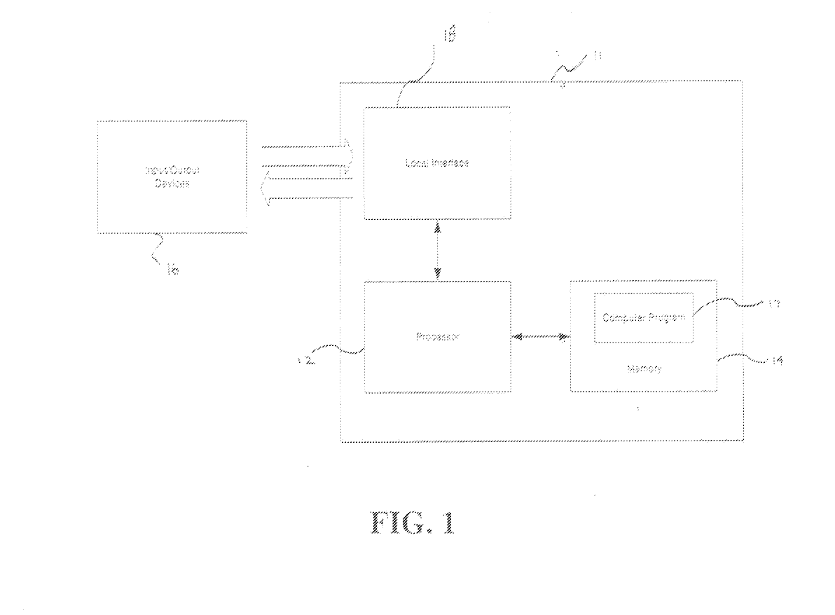

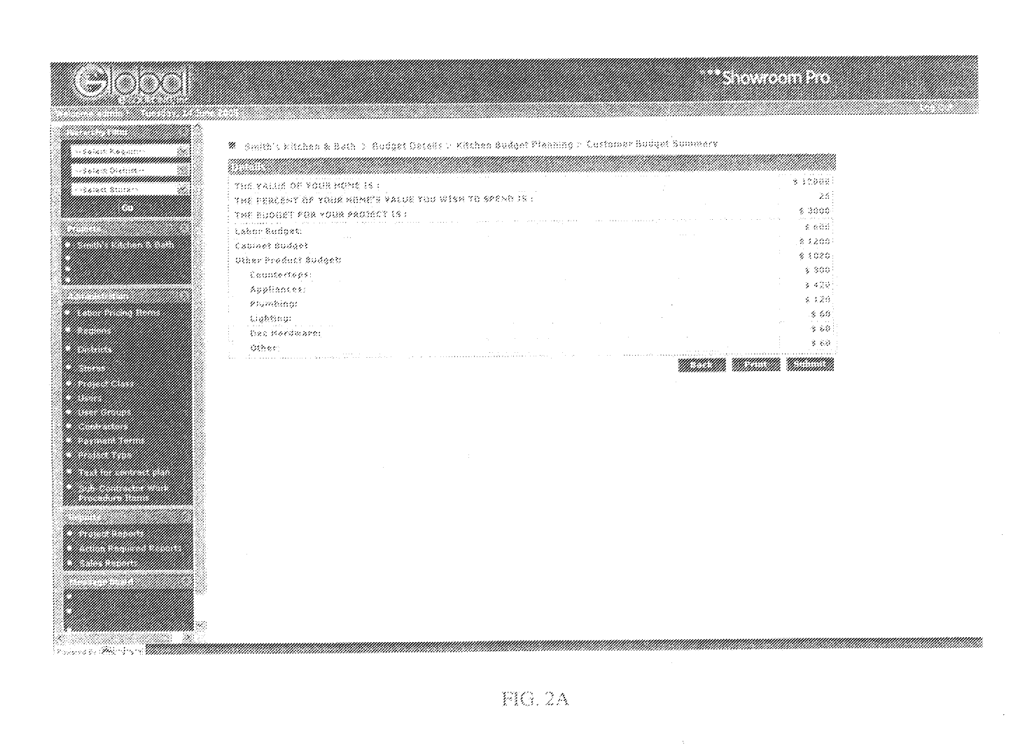

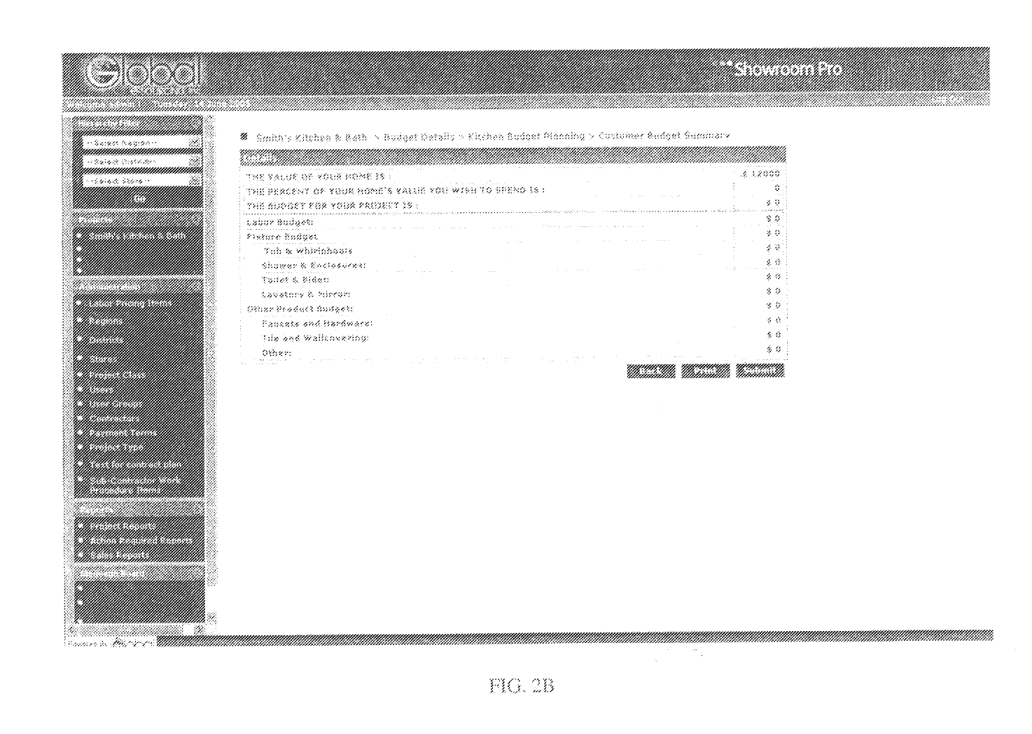

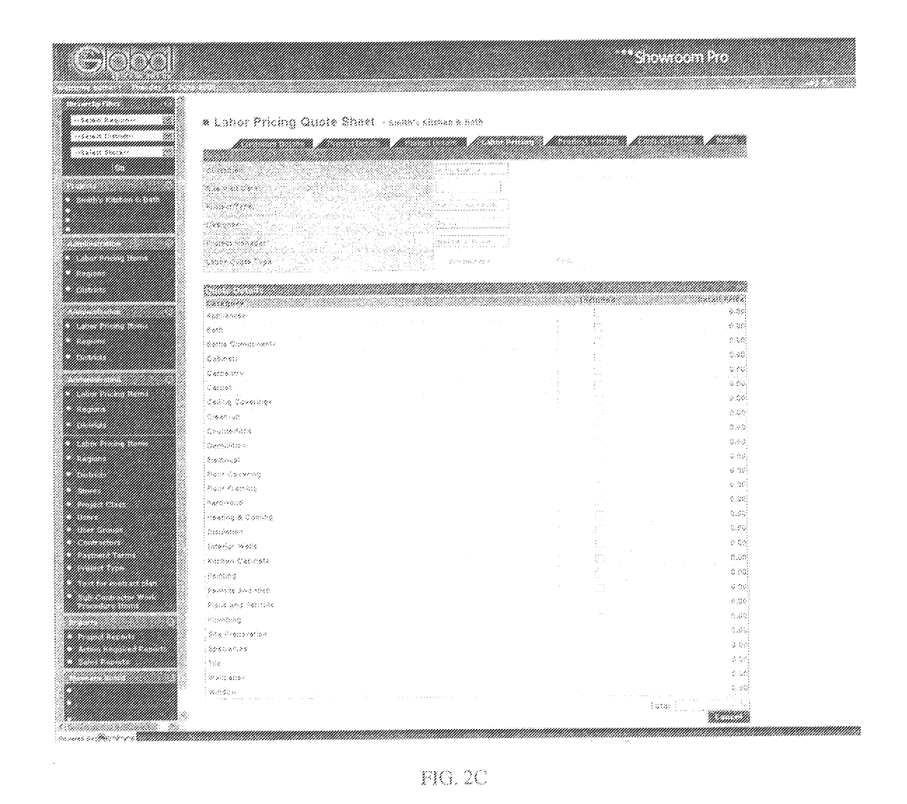

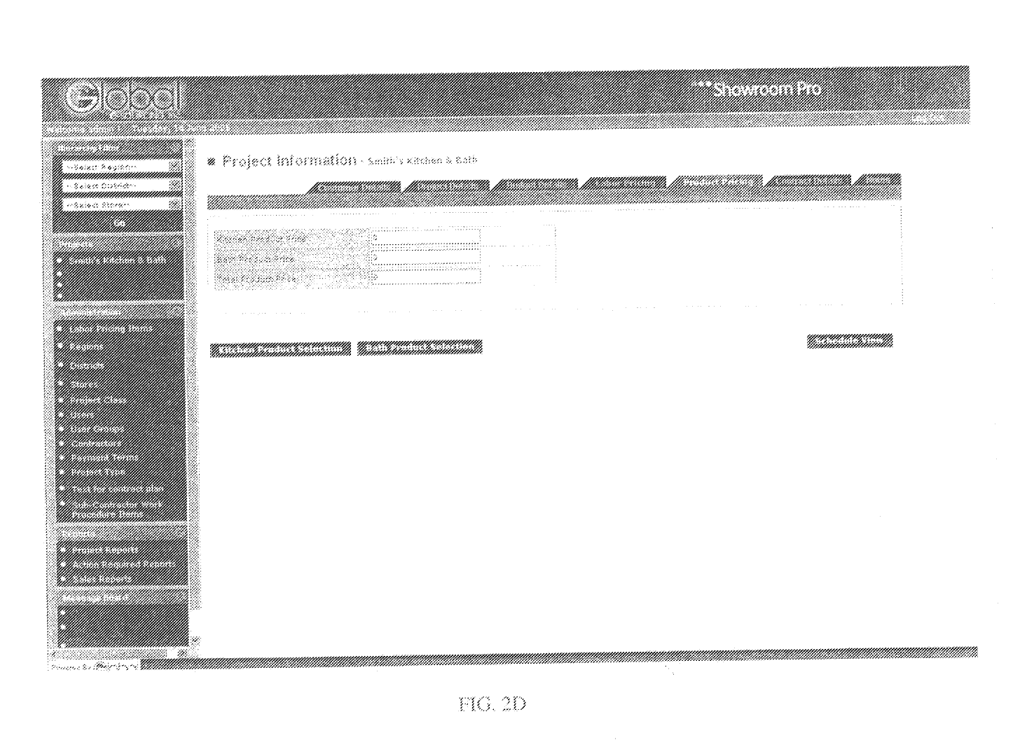

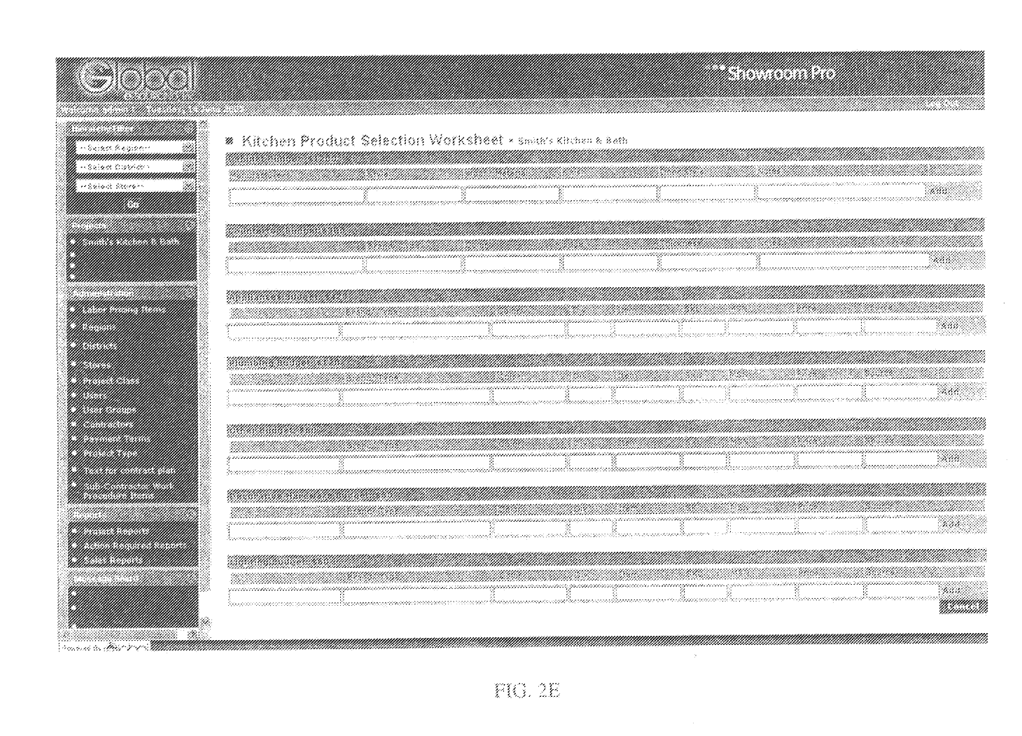

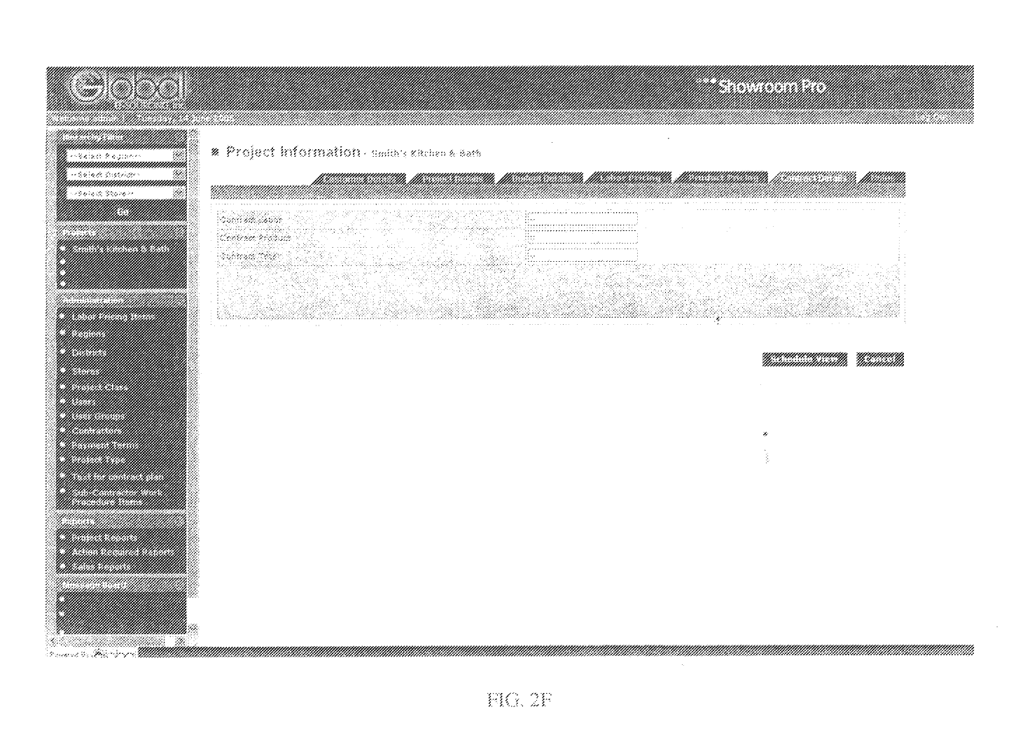

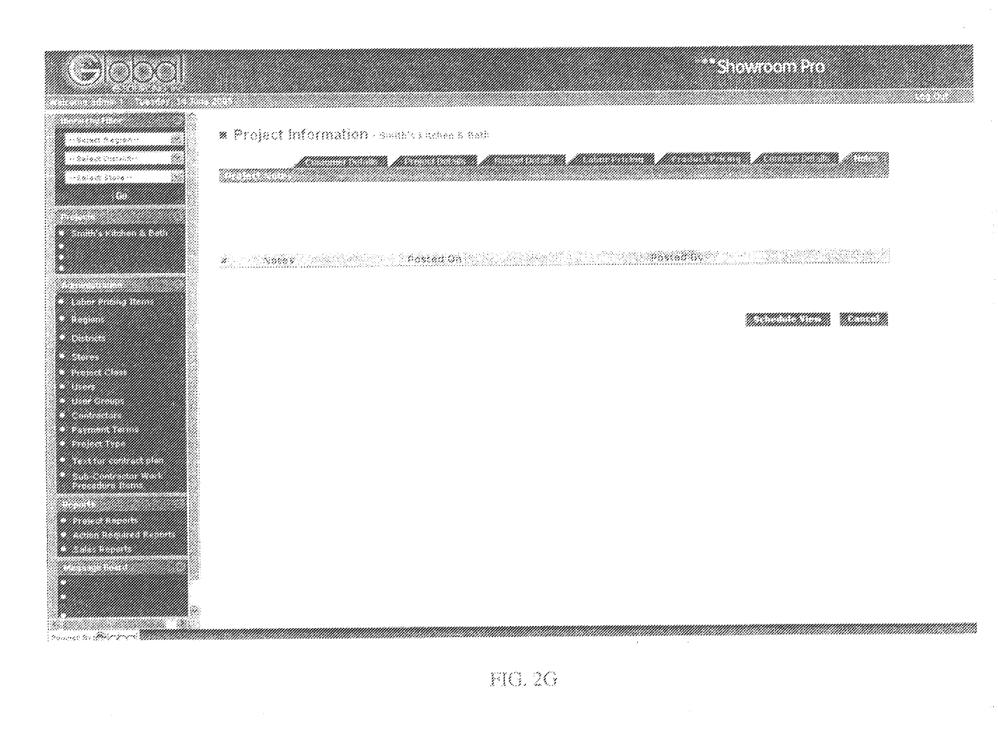

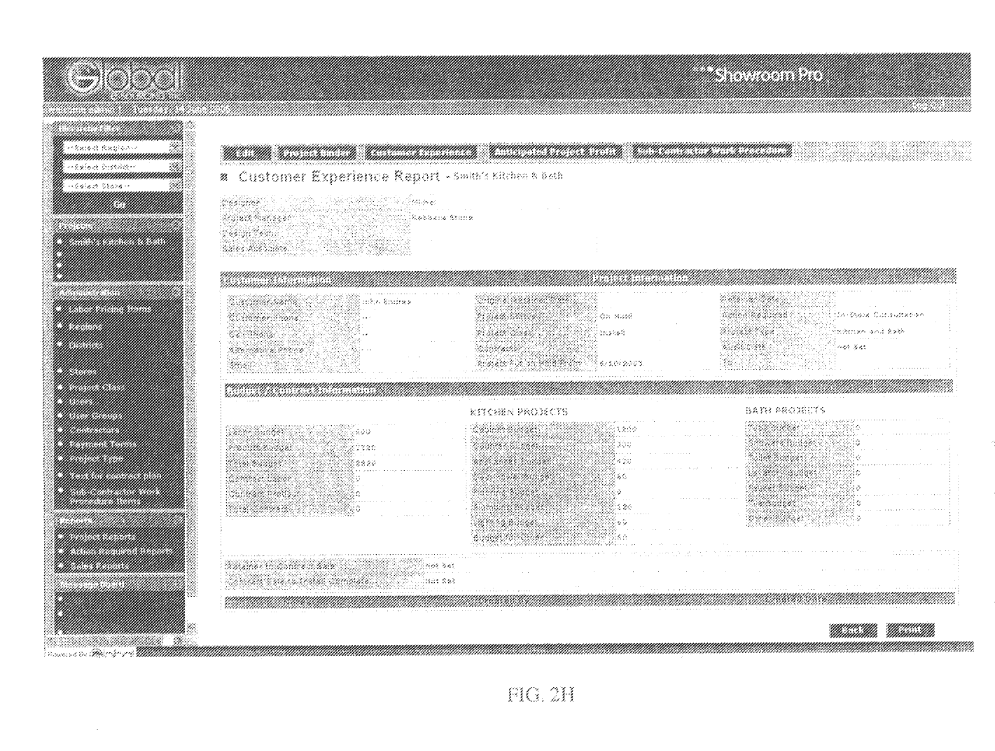

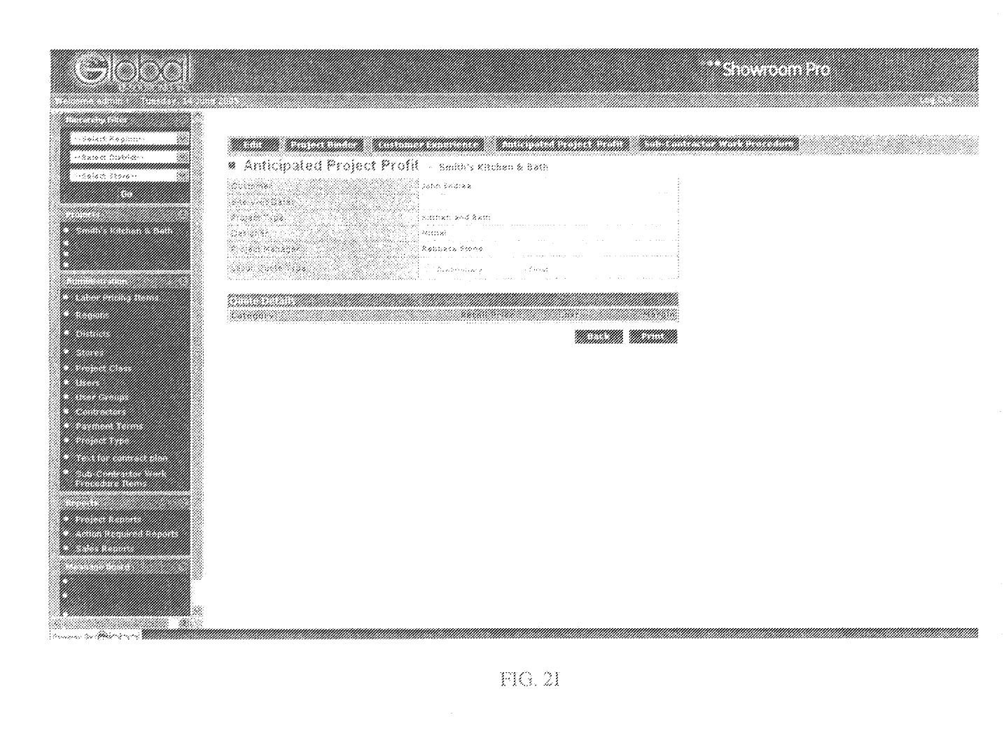

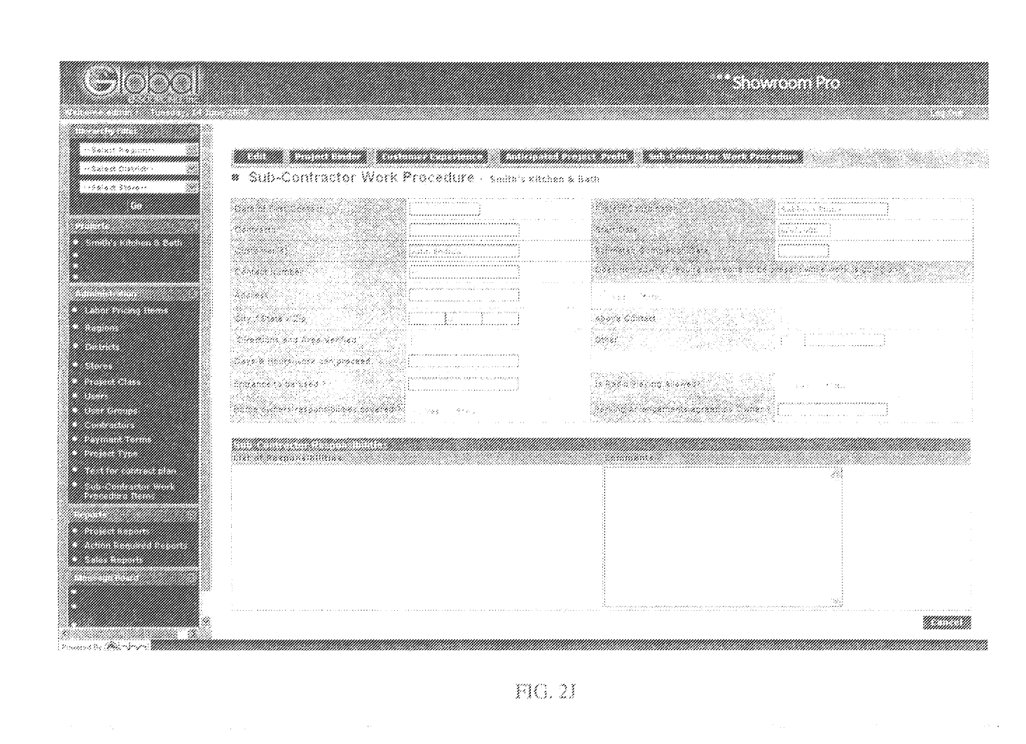

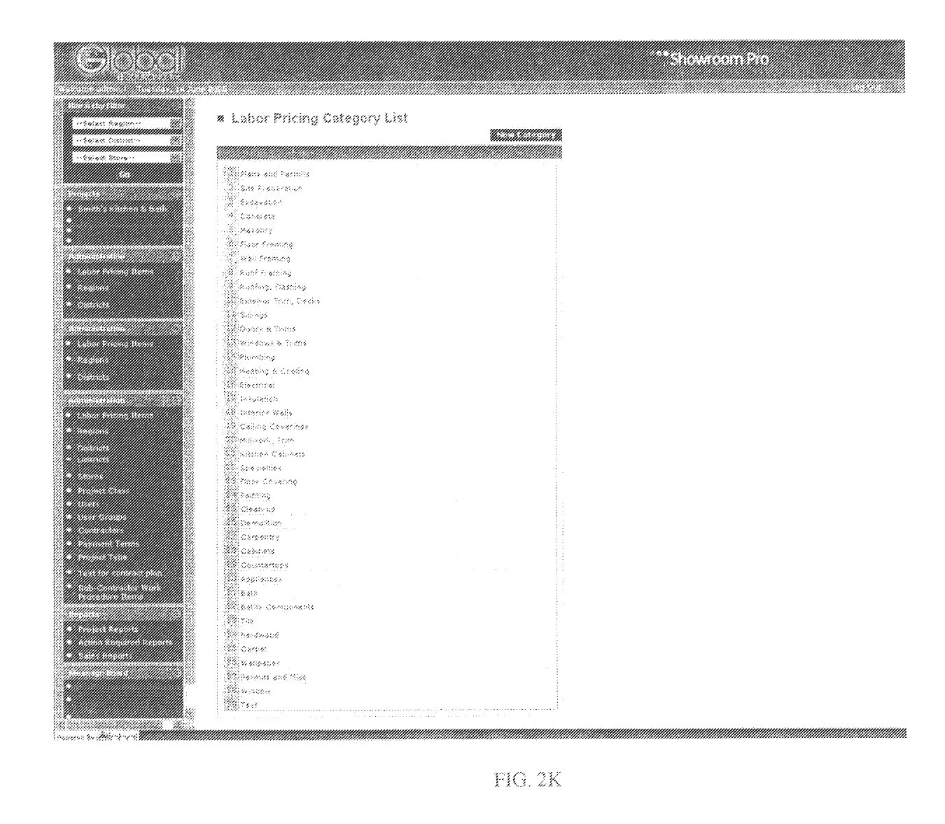

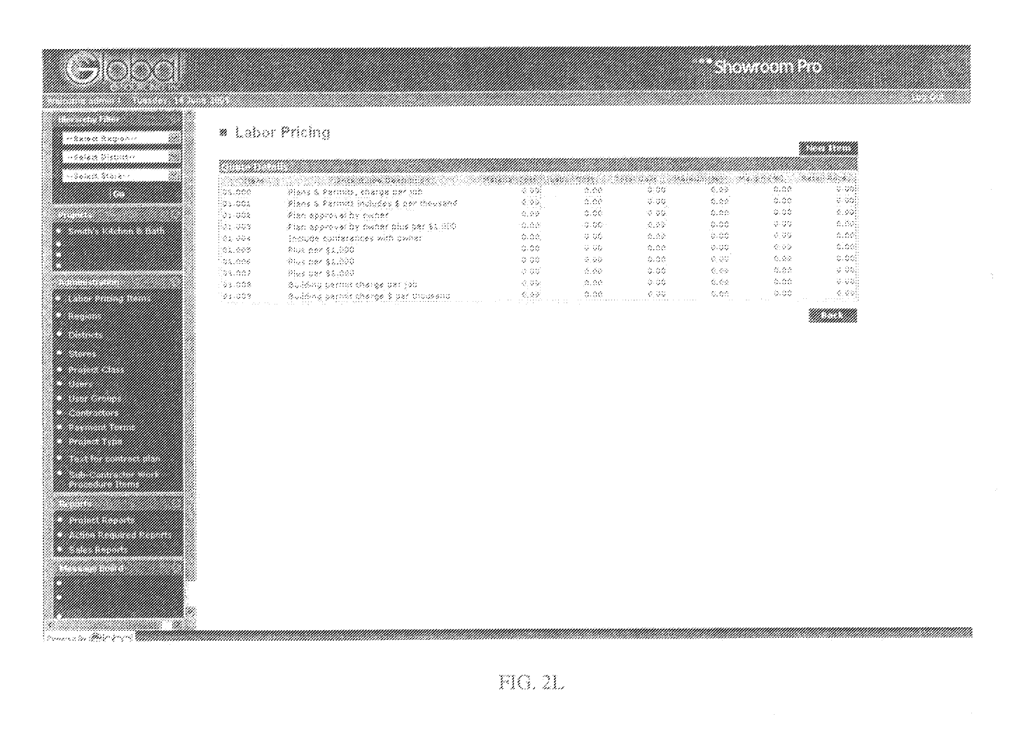

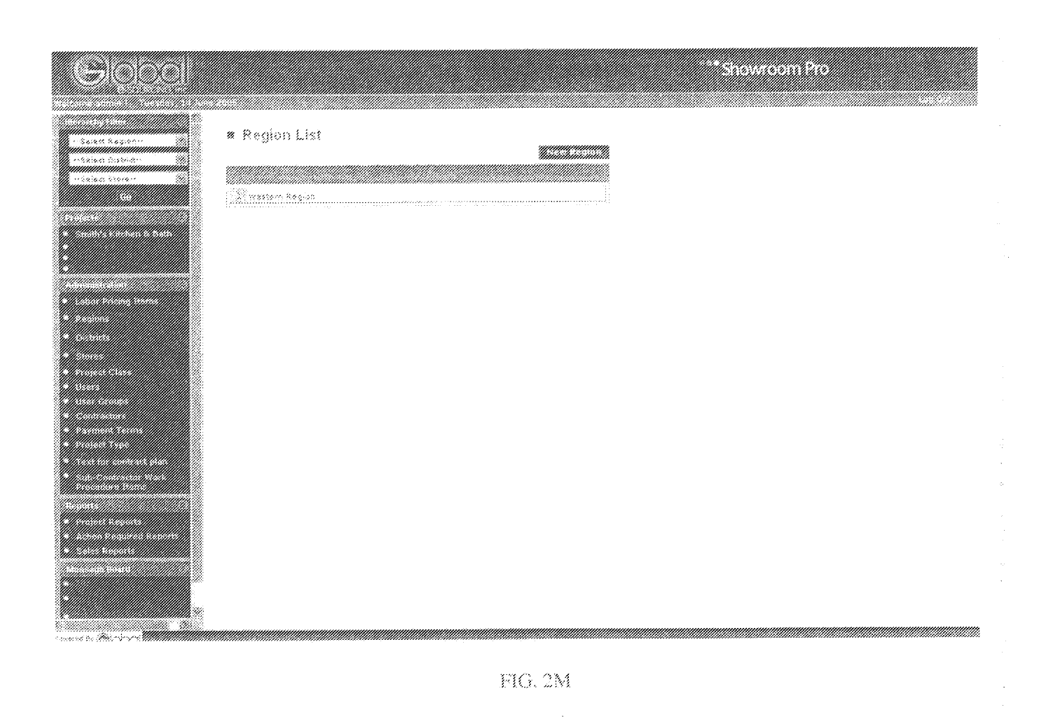

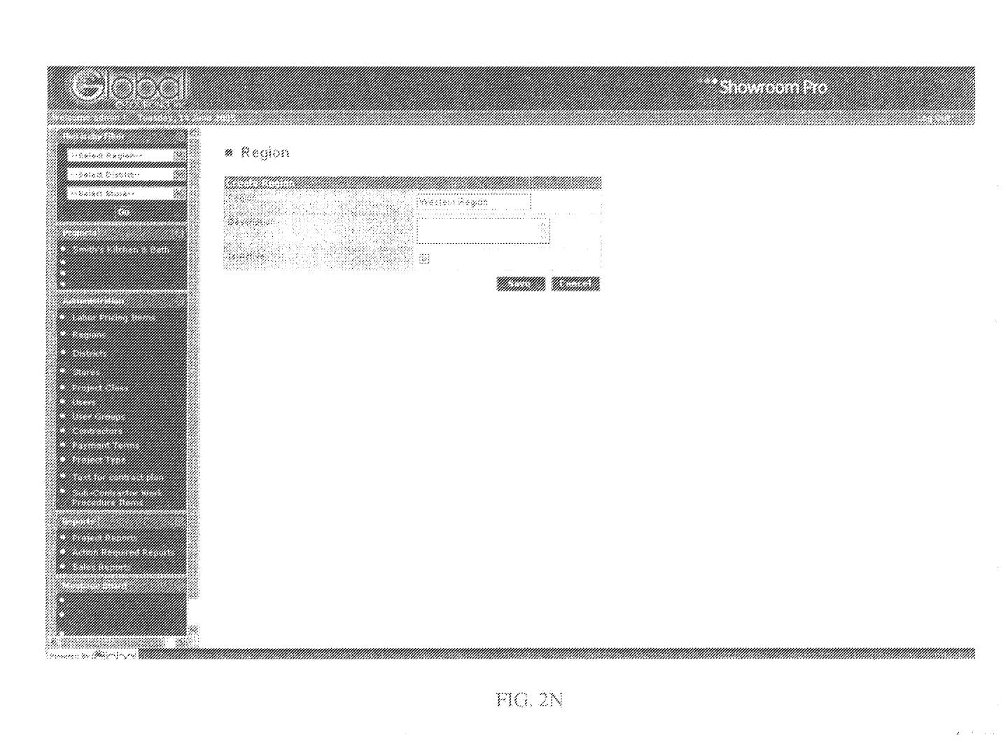

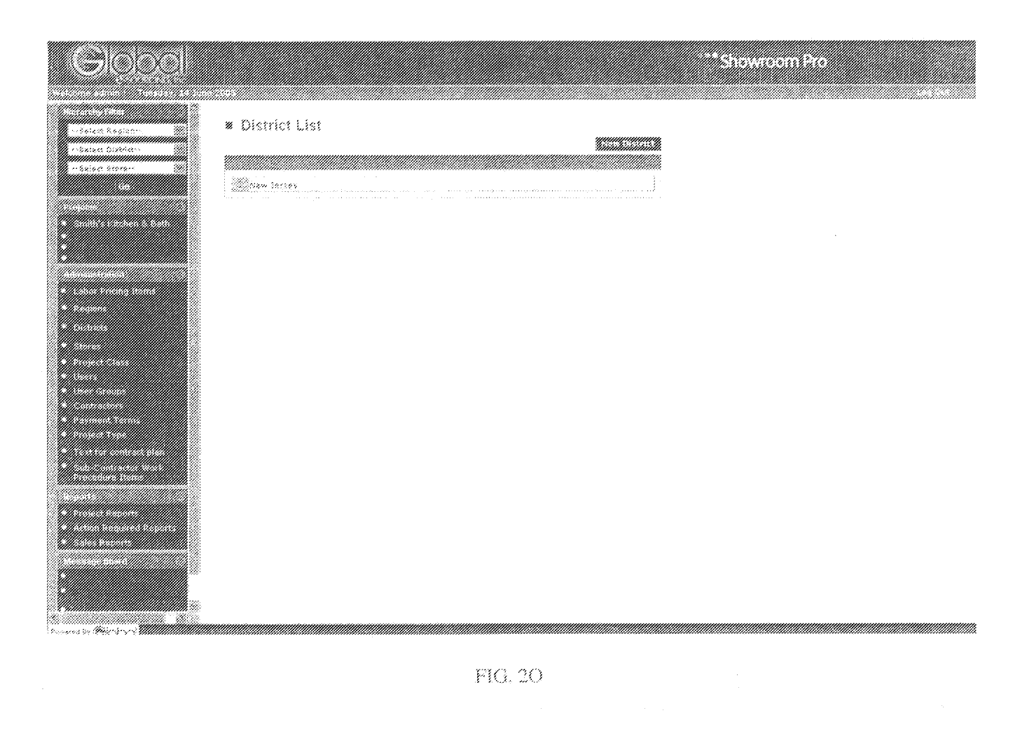

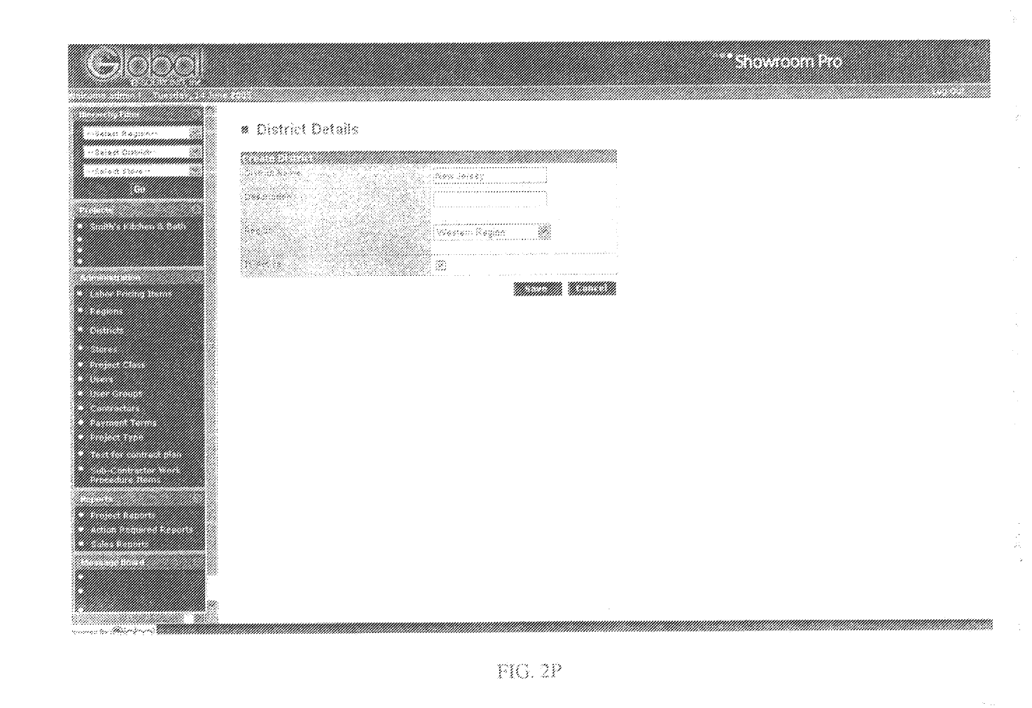

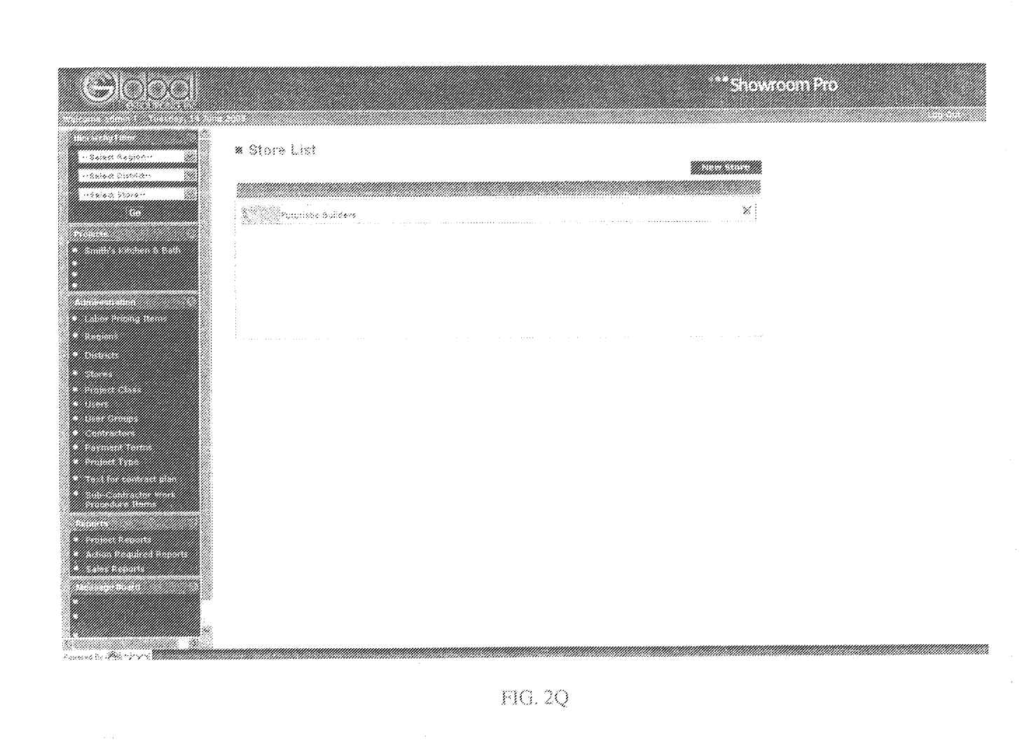

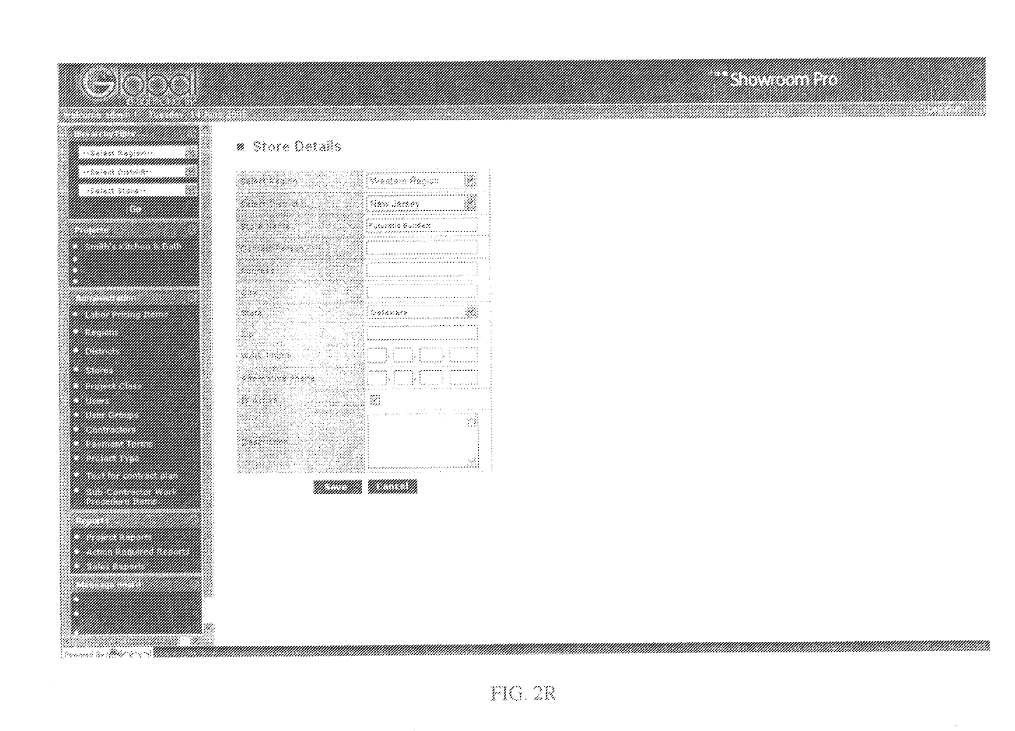

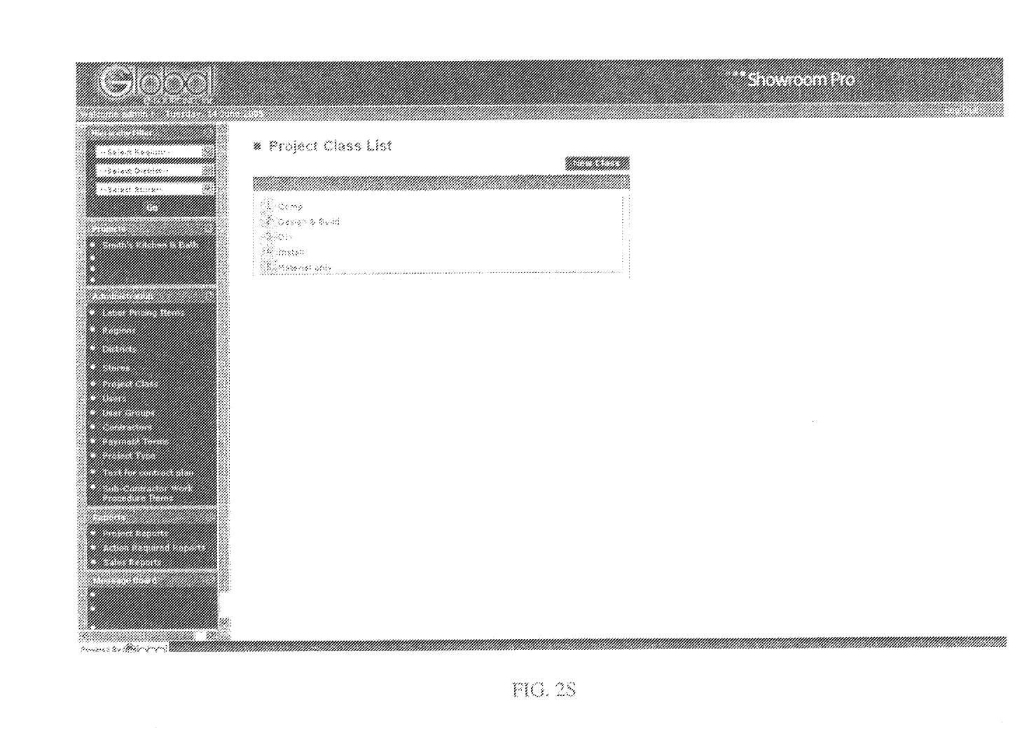

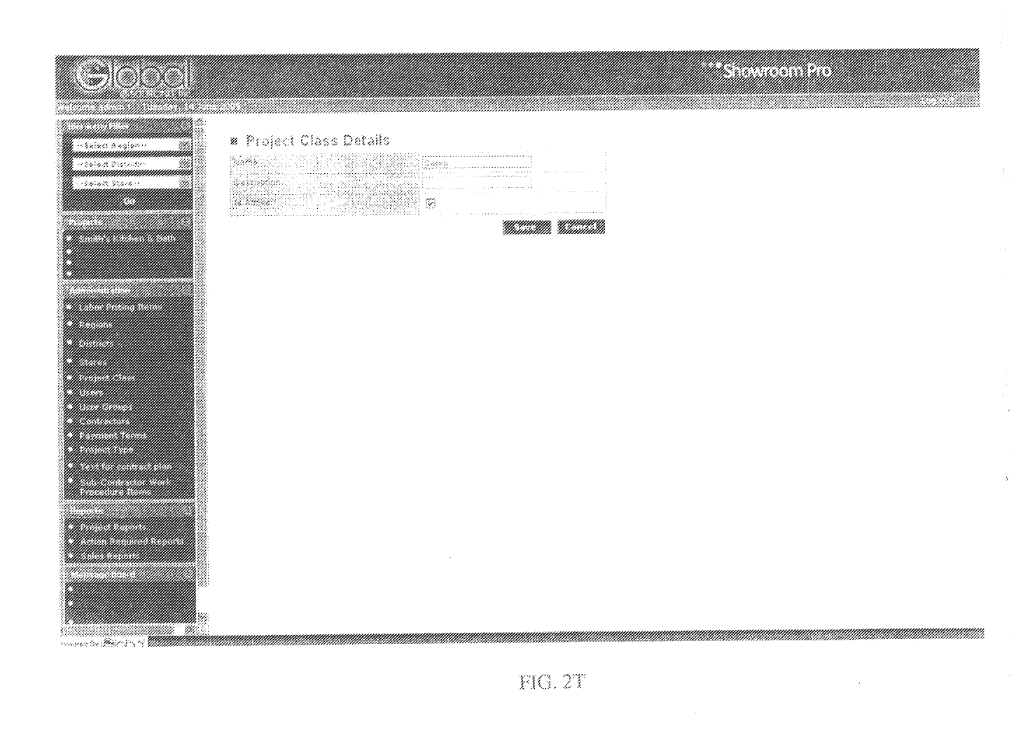

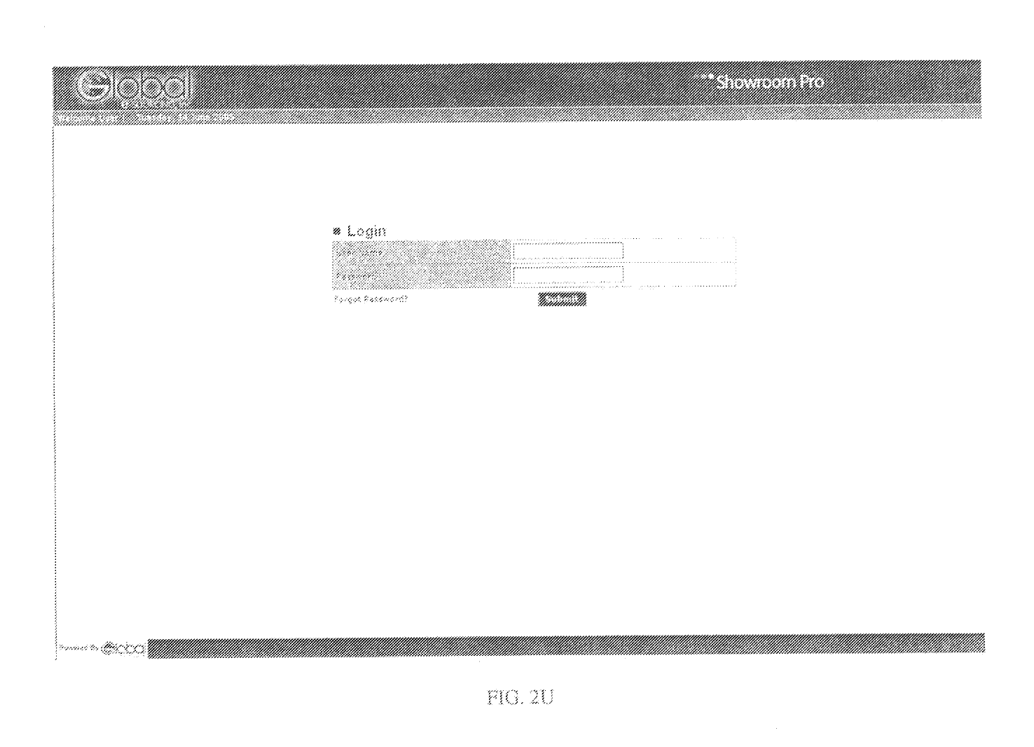

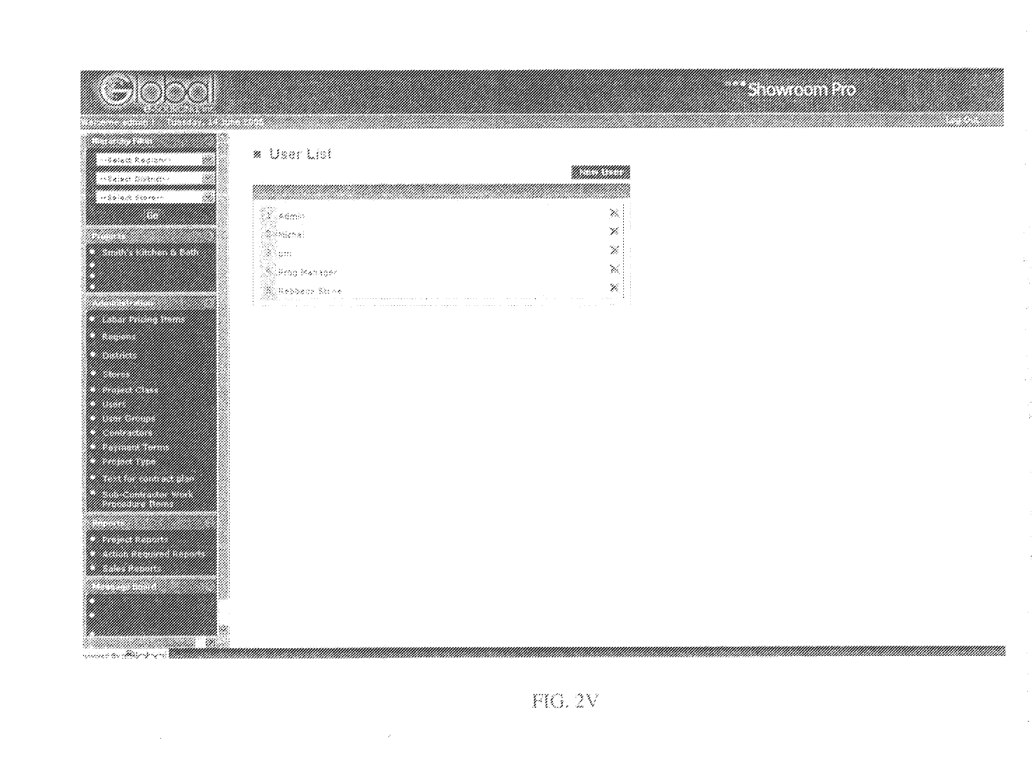

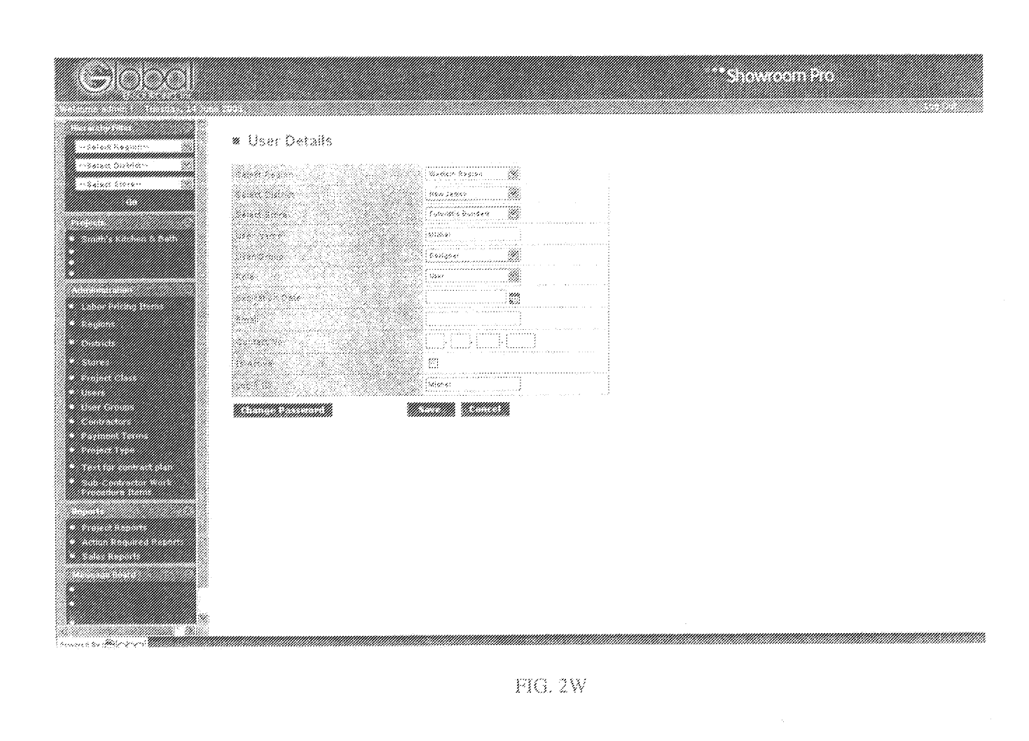

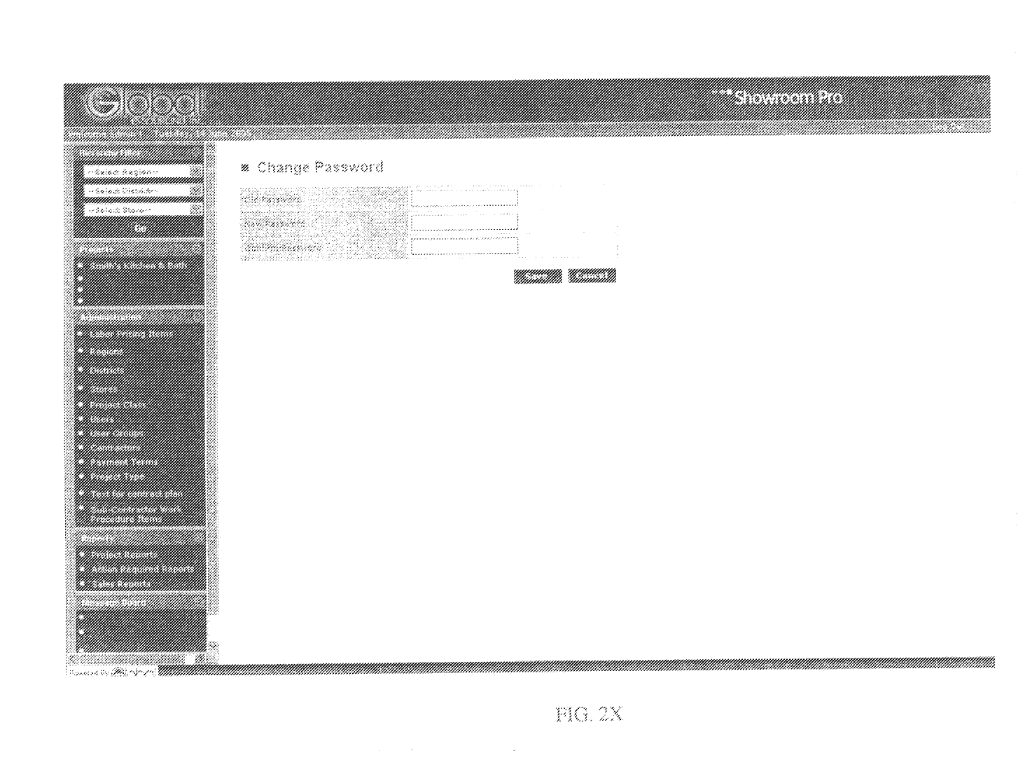

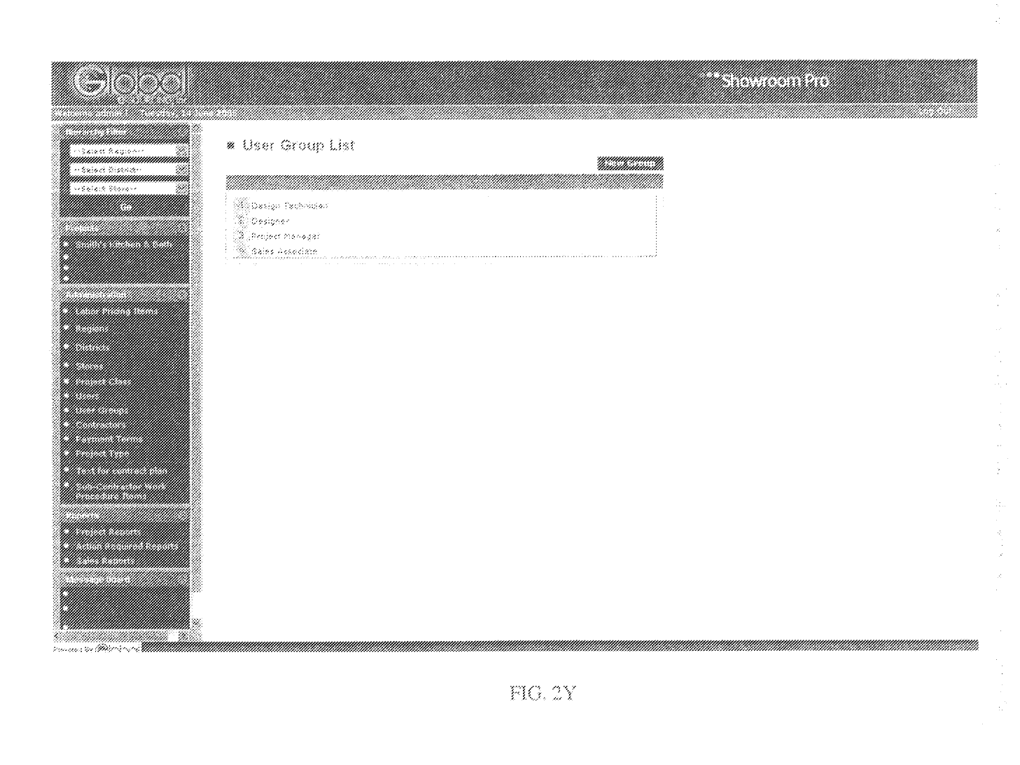

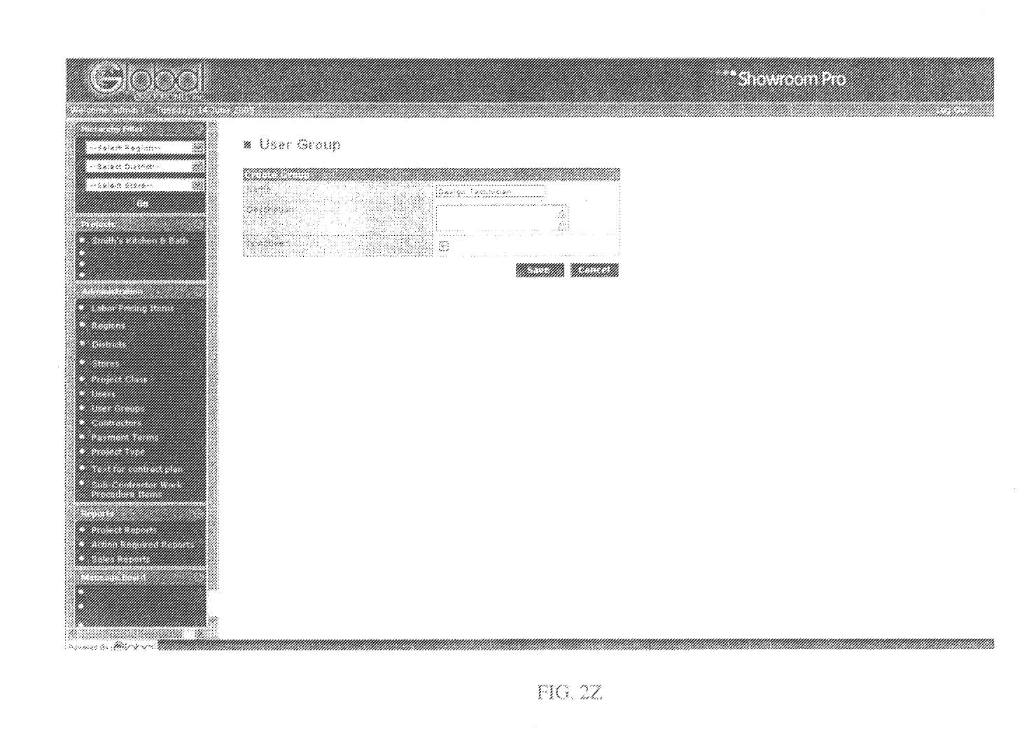

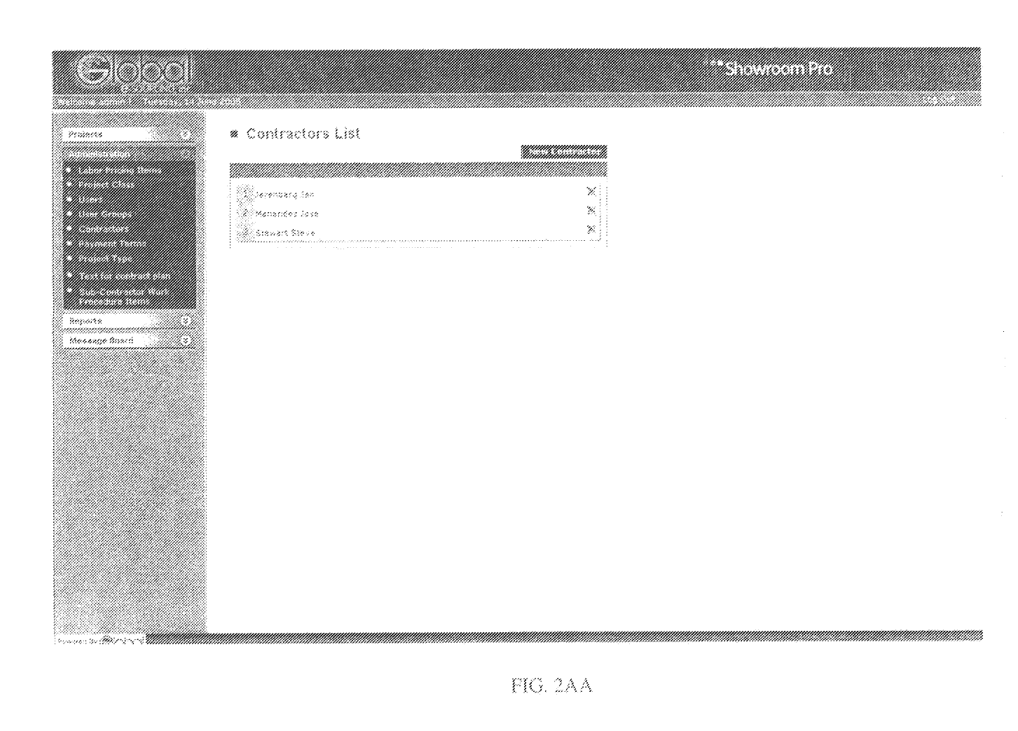

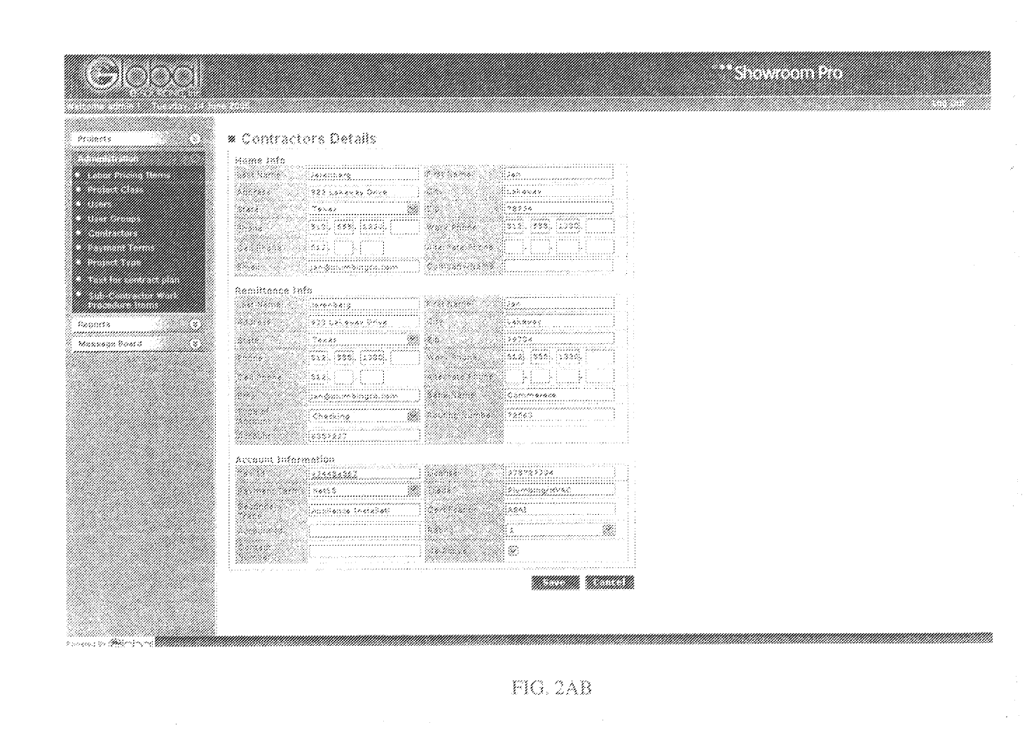

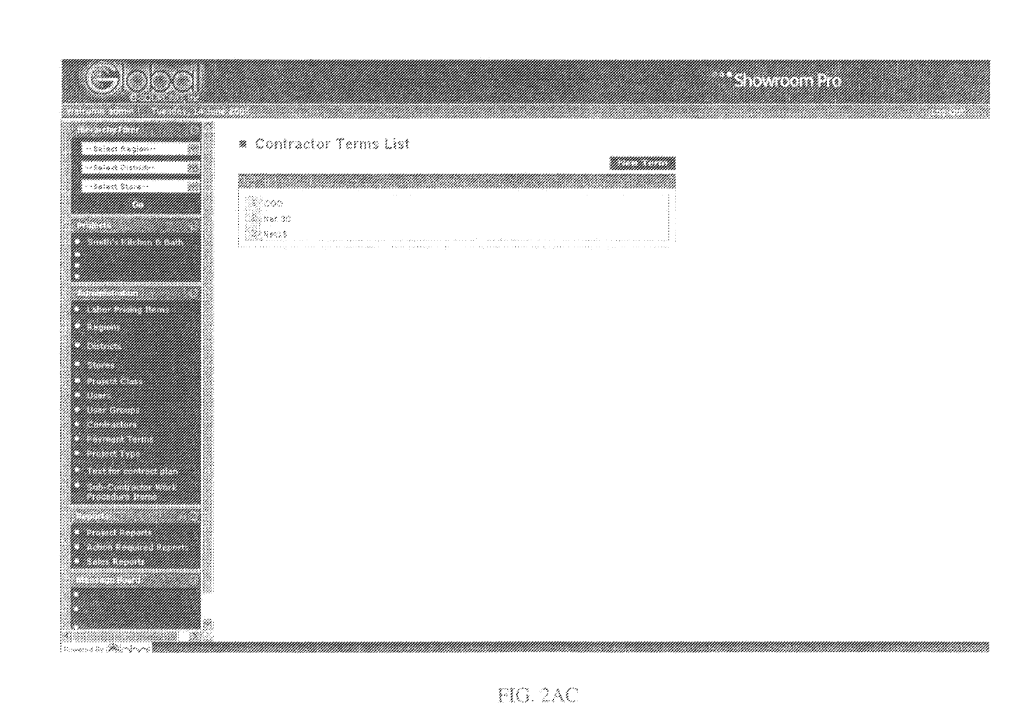

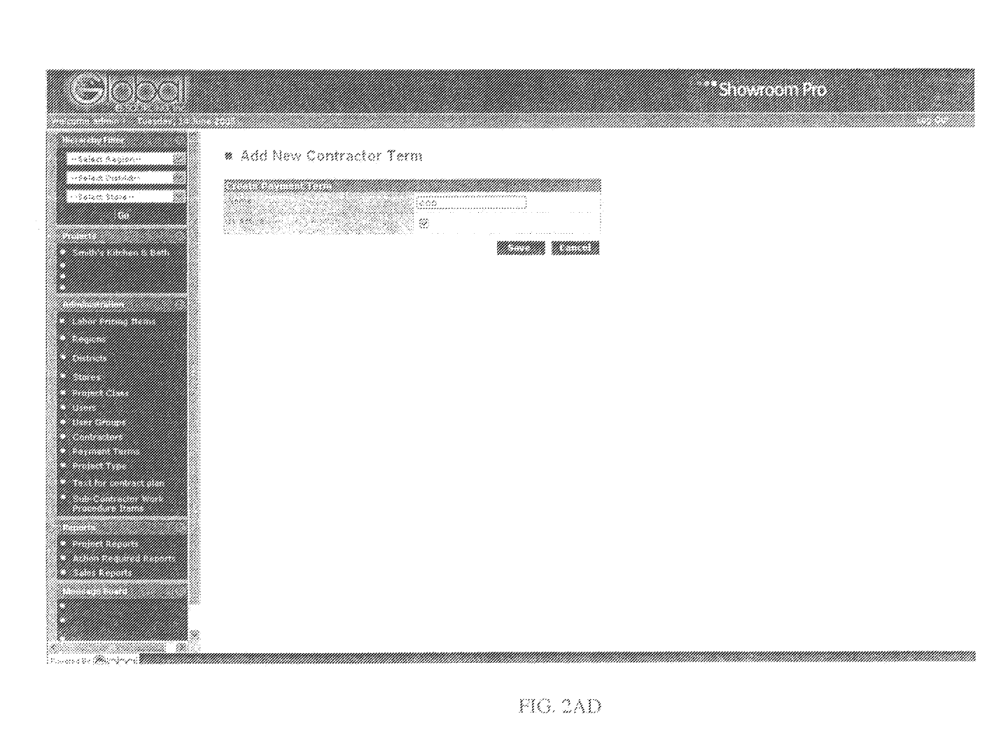

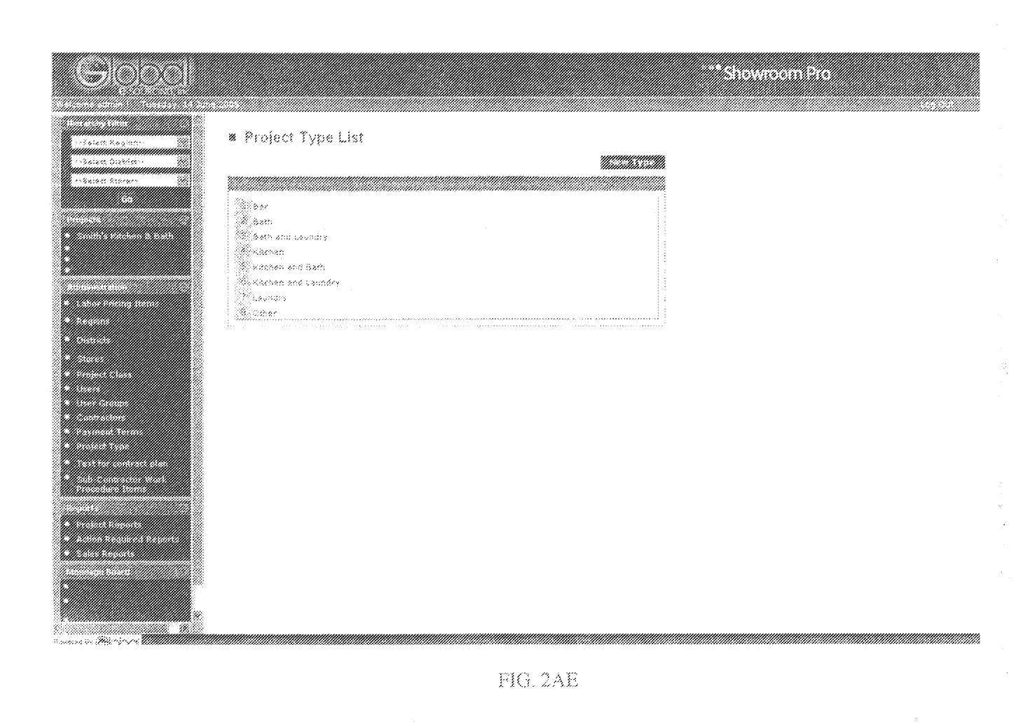

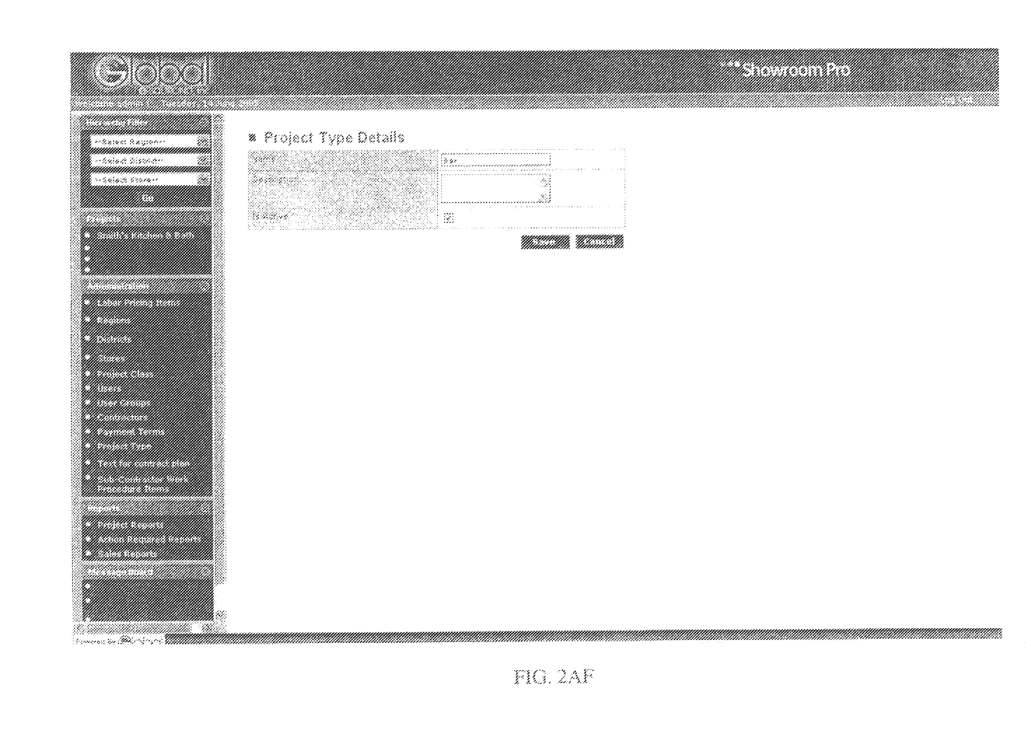

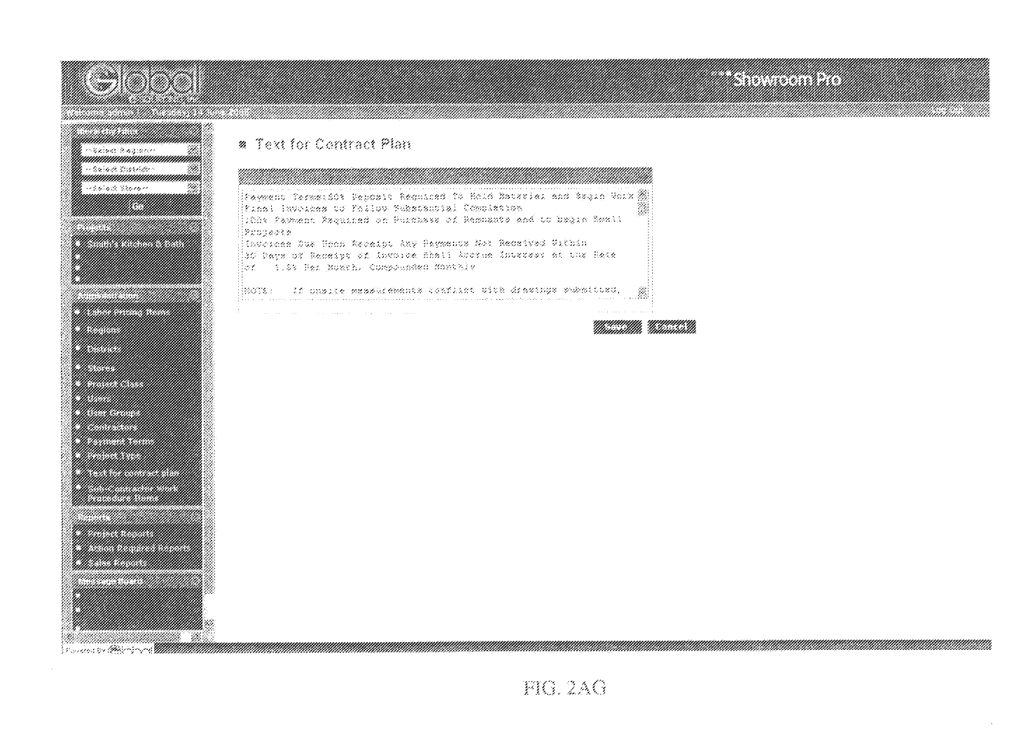

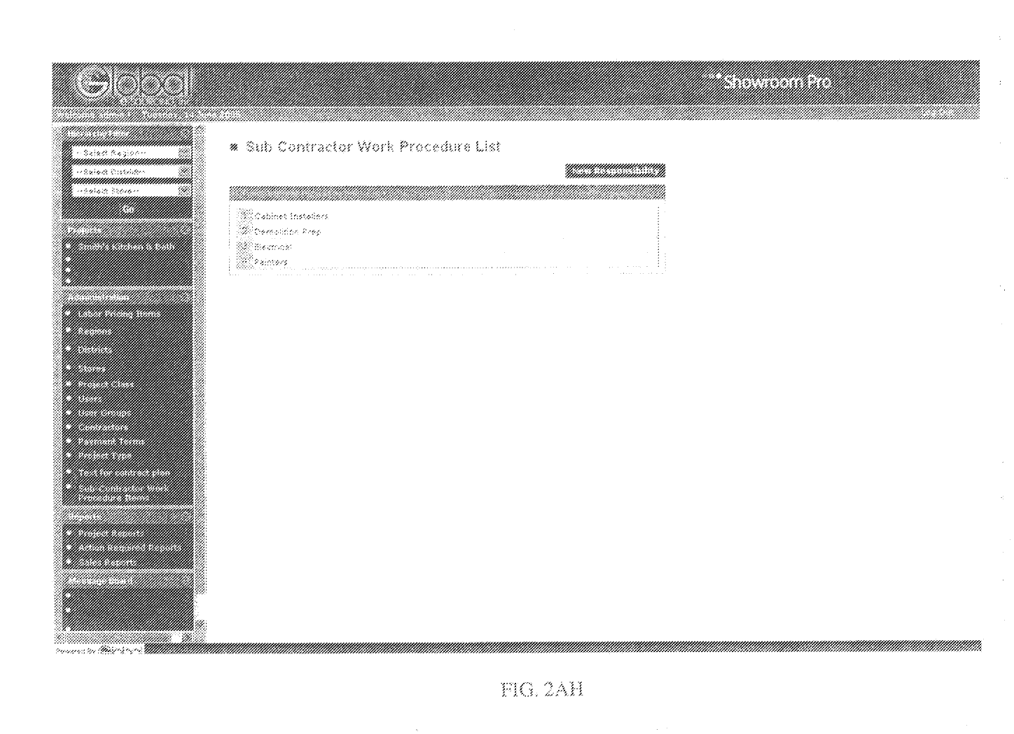

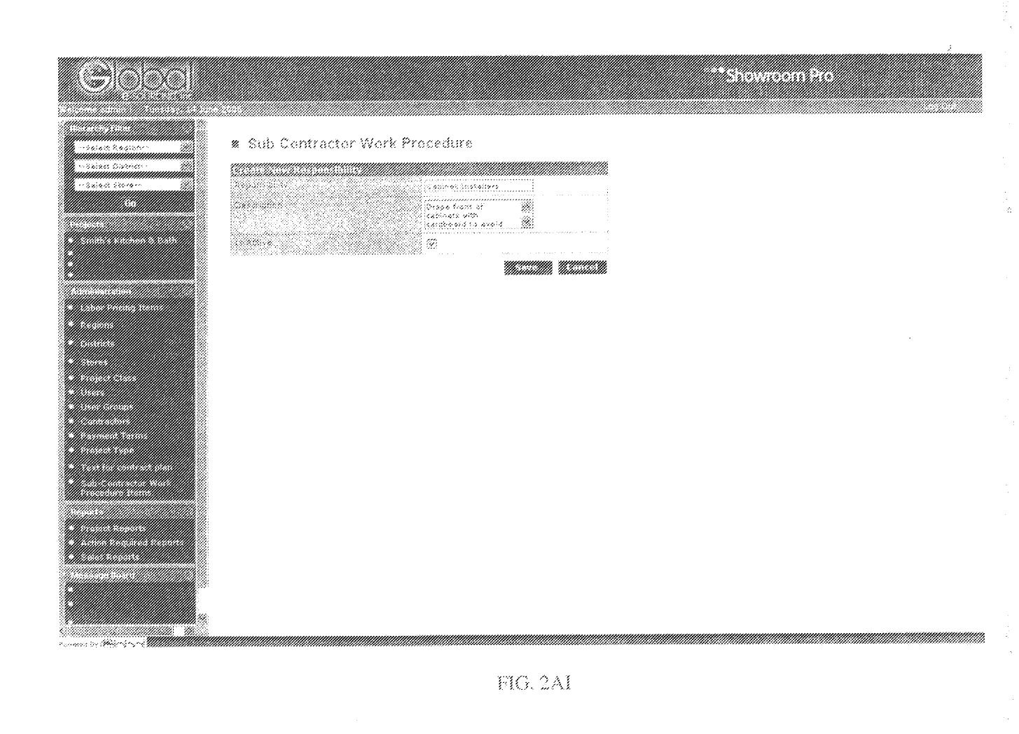

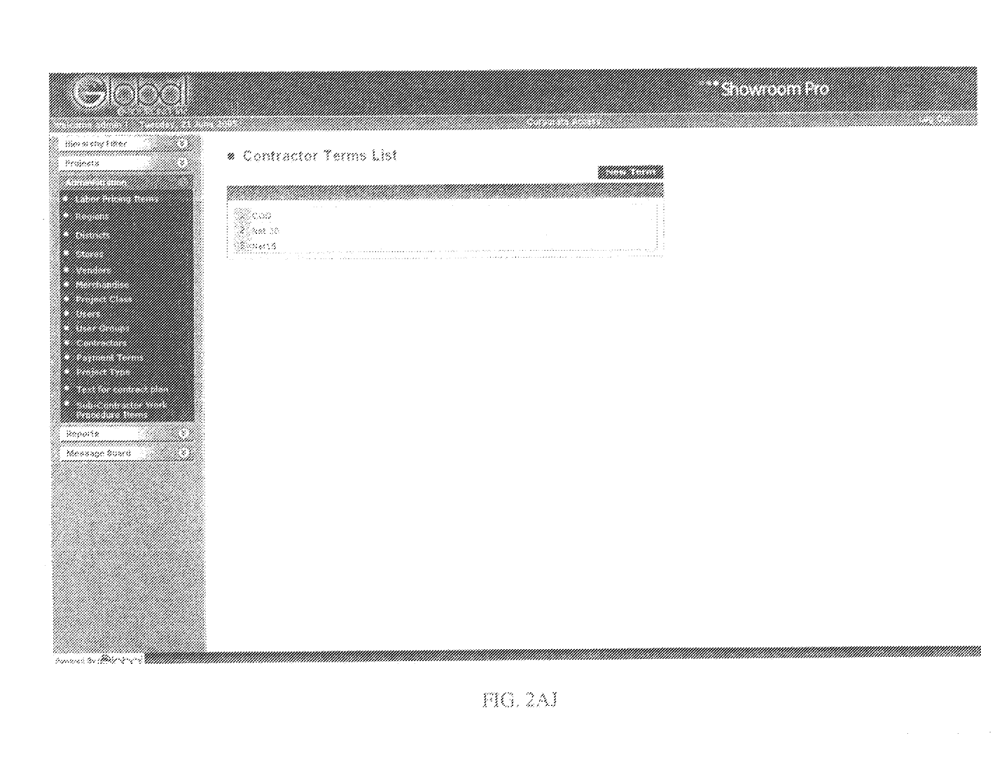

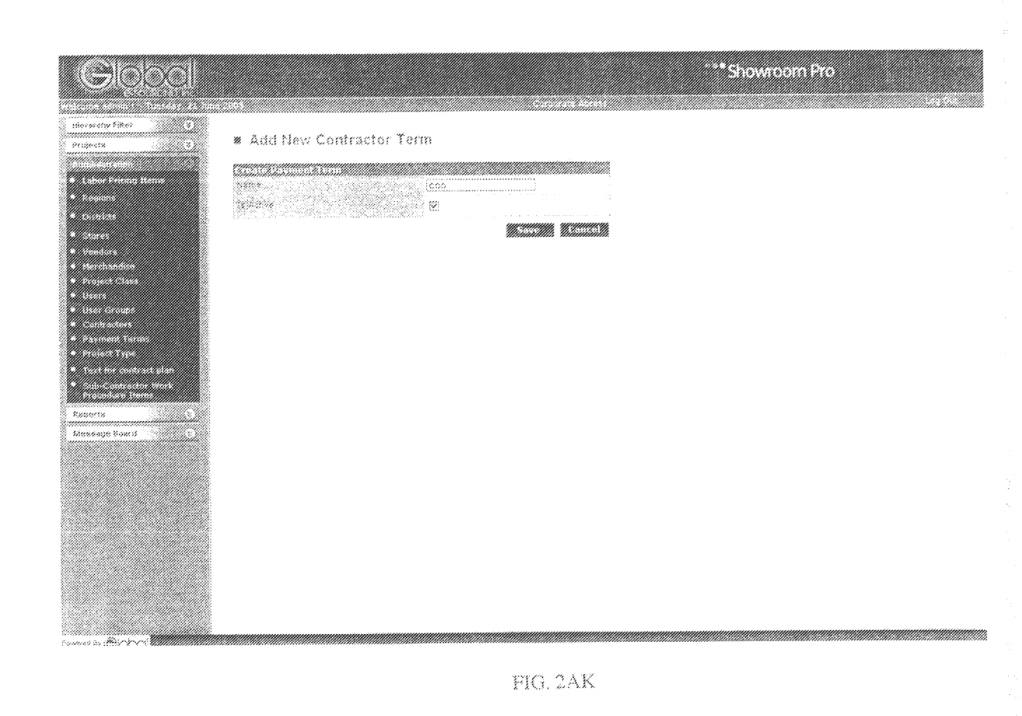

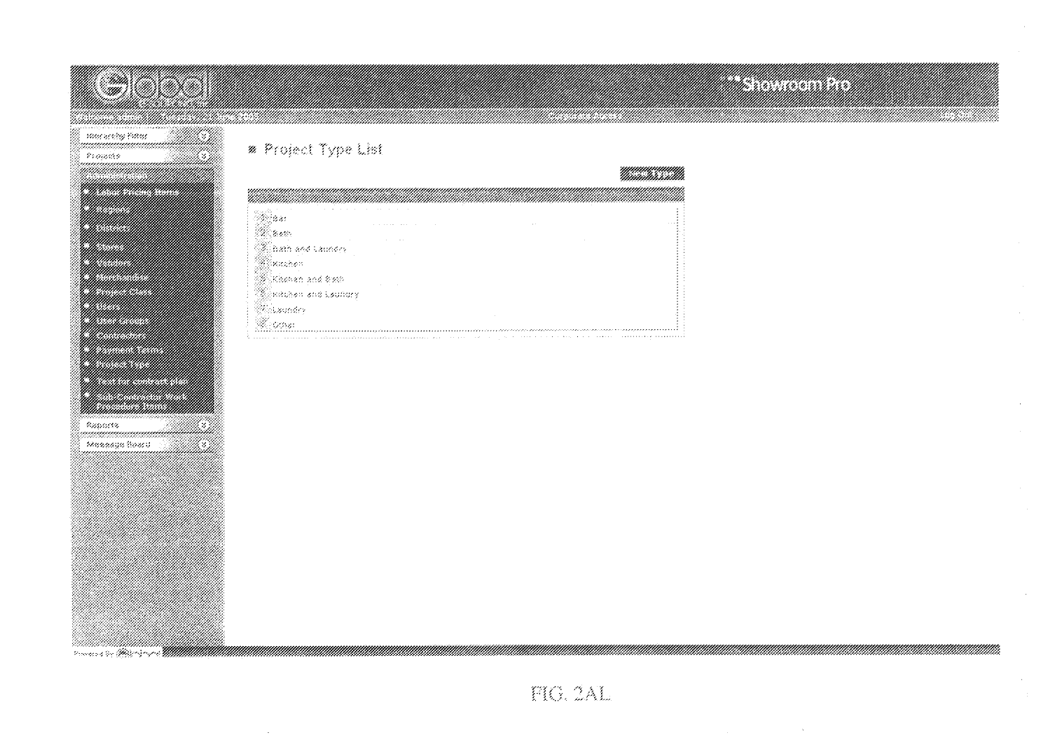

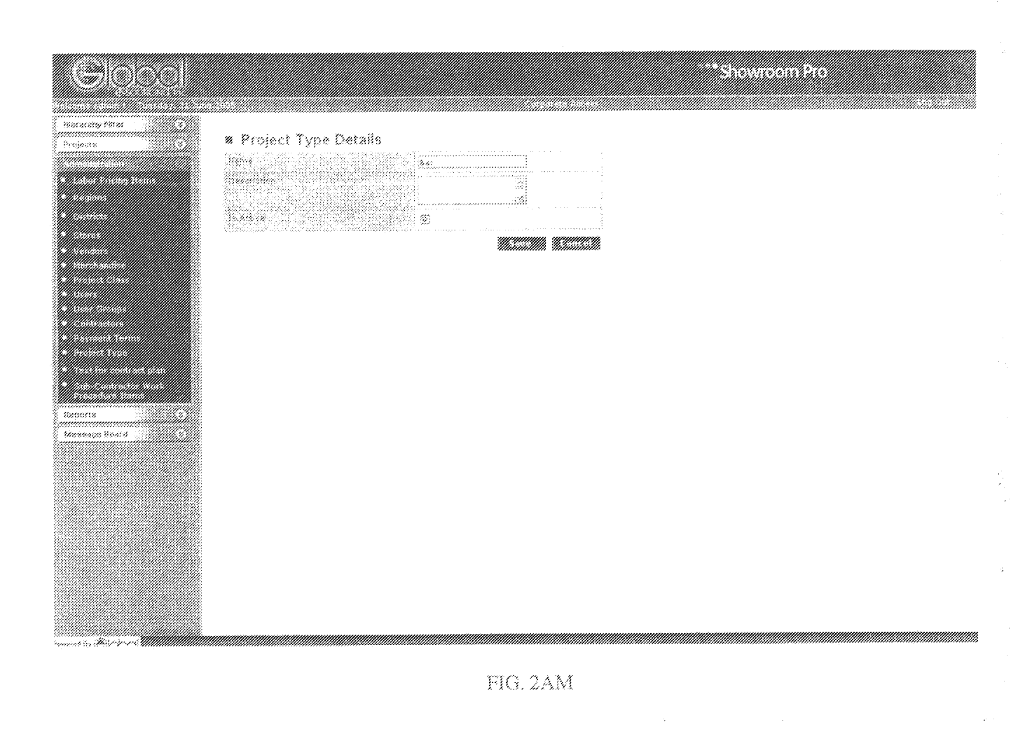

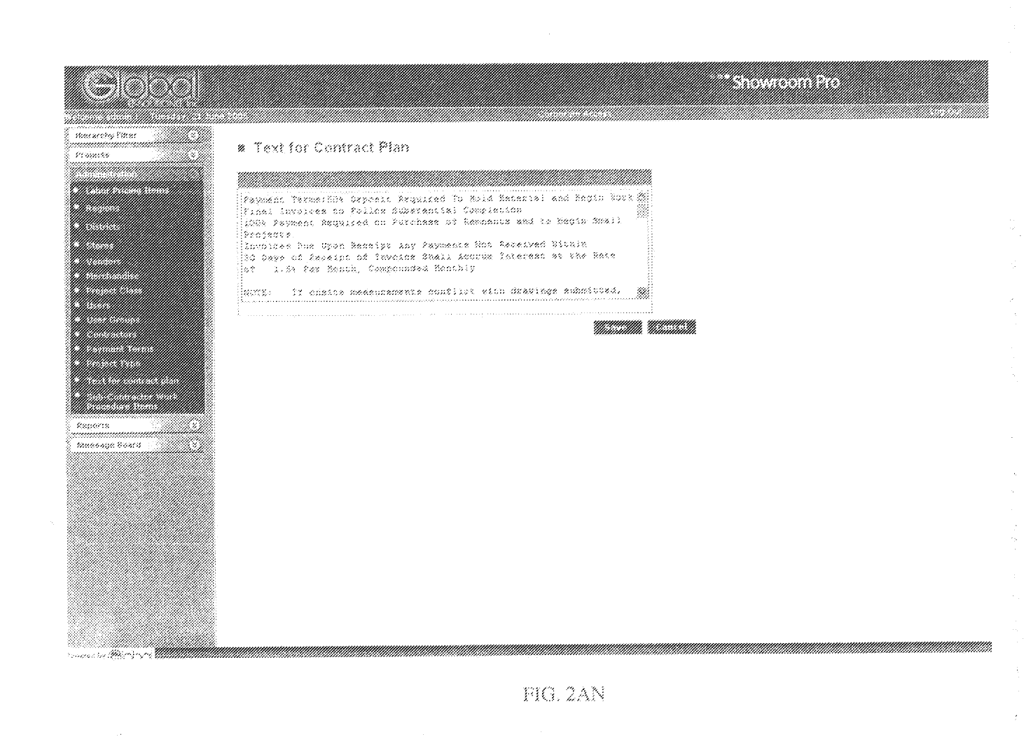

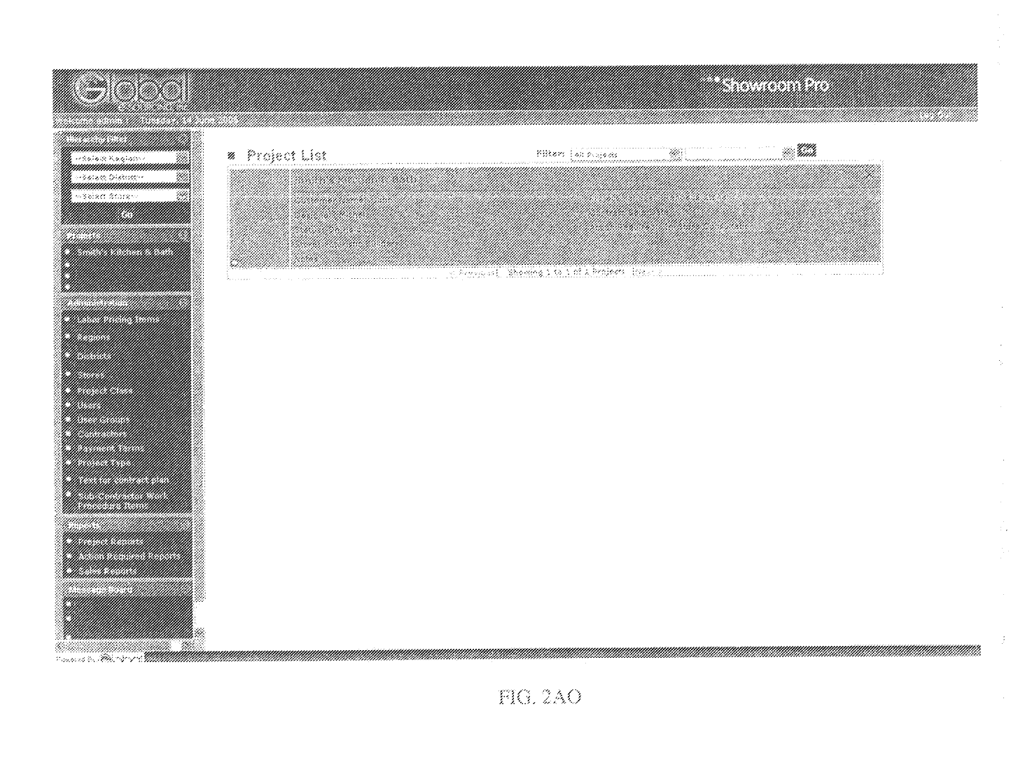

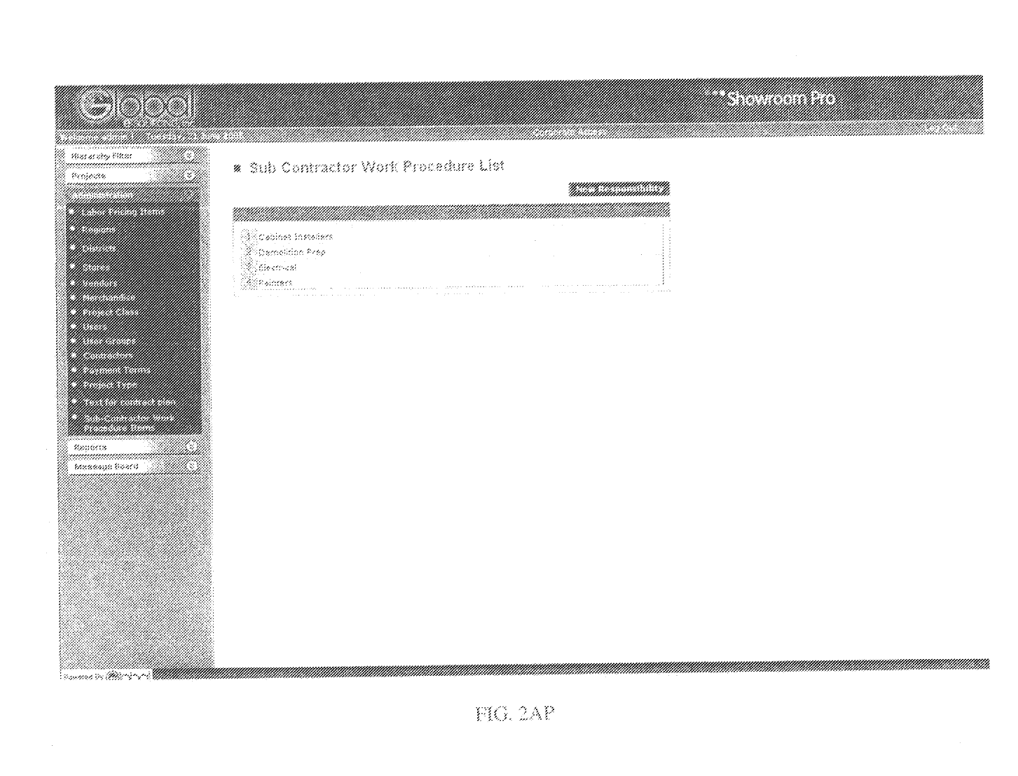

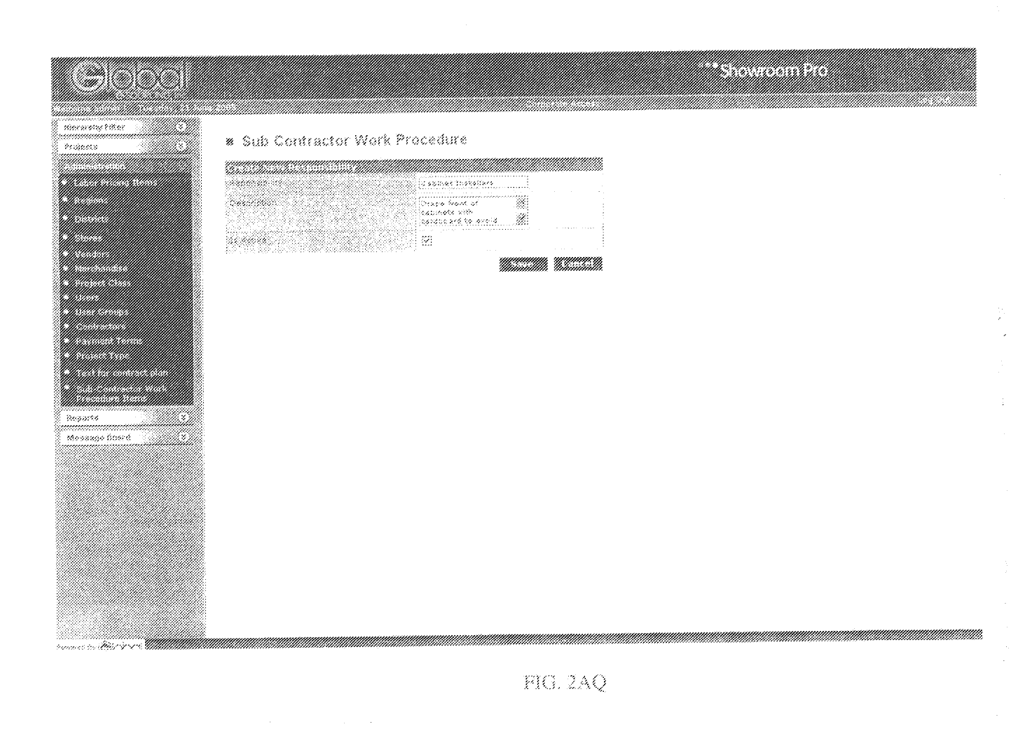

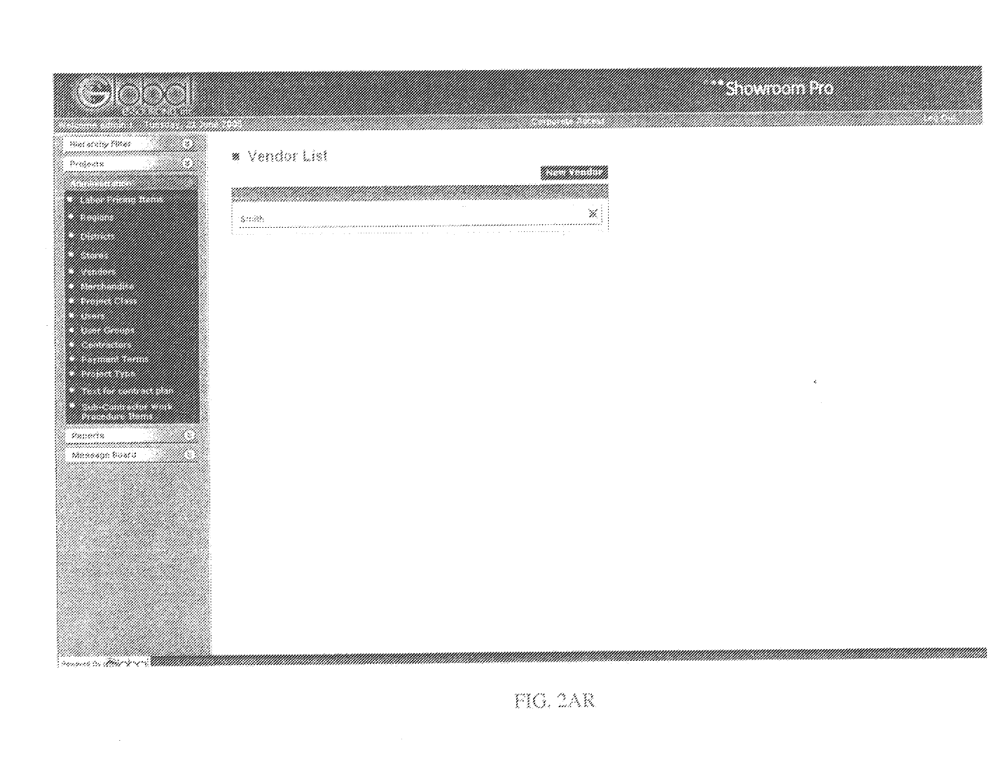

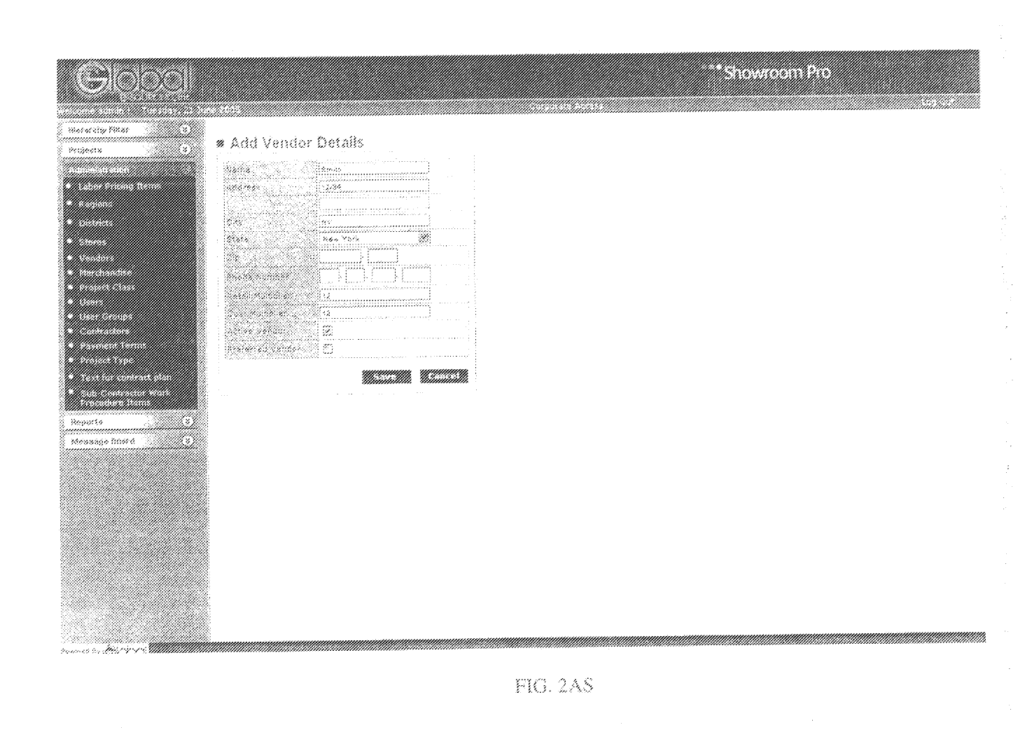

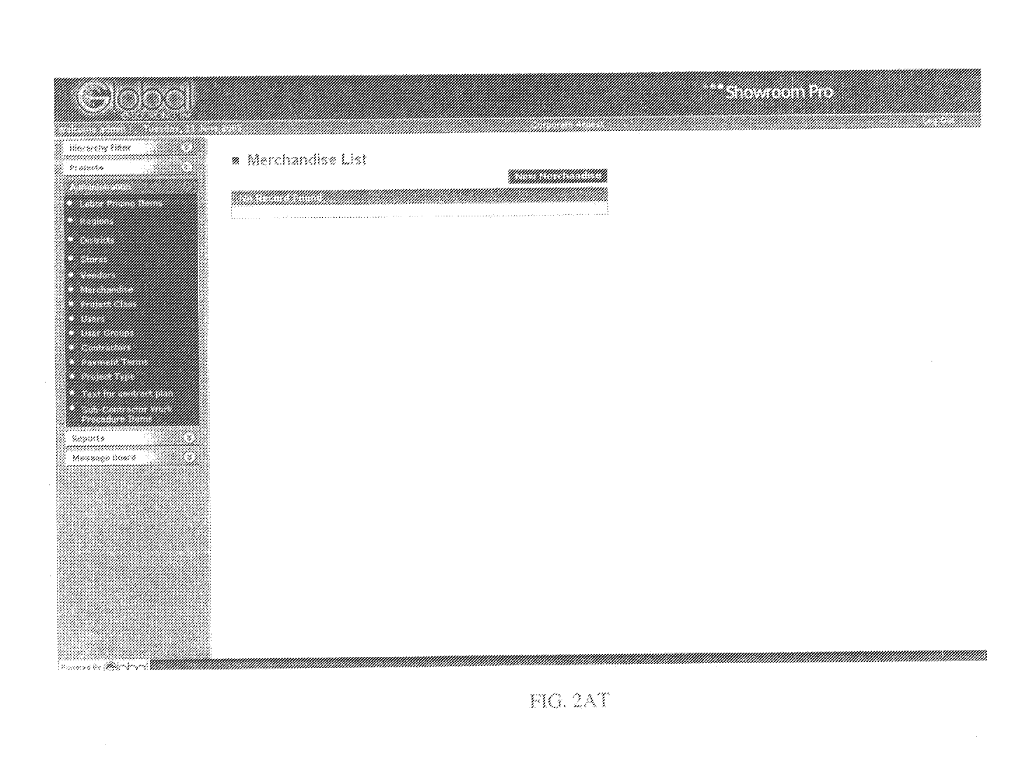

FIG. 1 is a block diagram of a computer or server 11. For purposes of understanding the hardware as described herein, the terms “computer” and “server” have identical meanings and are interchangeably used. Computer 11 includes management system 17. The management system 17 of the invention can be implemented in software (e.g., firmware), hardware, or a combination thereof. In the currently contemplated best mode, the management system 17 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the management system 17 of the present invention is shown in FIG. 1. The management system 17 may reside in, or have portions residing in, any computer such as, but not limited to, a general purpose personal computer. Therefore, computer 11 of FIG. 1 may be representative of any computer in which the management system 17 resides or partially resides.

Generally, in terms of hardware architecture, as shown in FIG. 1, the computer 11 includes a processor 12, memory 14, and one or more input and/or output (I/O) devices 16 (or peripherals) that are communicatively coupled via a local interface 18. The local interface 18 can be, for example, but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 12 is a hardware device for executing software, particularly software stored in memory 14. The processor 12 can be any custom made or commercially available processor, a central processing unit (CPU), an auxiliary processor among several processors associated with the computer 11, a semiconductor based microprocessor (in the form of a microchip or chip set), a macroprocessor, or generally any device for executing software instructions. Examples of suitable commercially available microprocessors are a PA-RISC series microprocessor from Hewlett-Packard Company, an 80×8 or Pentium series microprocessor from Intel Corporation and other similar such processors.

The memory 14 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 14 may incorporate electronic, magnetic, optical, and/or other types of storage media. The memory 14 can have a distributed architecture where various components are situated remote from one another, but can be accessed by the processor 12.

The software in memory 14 may include one or more separate programs, each of which comprises an ordered listing of executable instructions for implementing logical functions. In the example of FIG. 1, the software in the memory 14 includes the management system 17 in accordance with the present invention and a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the management system 17, and provides scheduling, input-output control, file and data management, memory management, and communication control and related services.

The management system 17 may be a source program, executable program (object code), script, or any other entity comprising a set of instructions to be performed. When a source program, the program needs to be translated via a compiler, assembler, interpreter, or the like, which may or may not be included within the memory 14, so as to operate properly in connection with the O/S. Furthermore, the management system 17 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In one embodiment, the management system 17 is written in C++. The I/O devices 16 may include input devices, for example but not limited to, a keyboard, mouse, scanner, microphone, touch screens, interfaces for various medical devices, bar code readers, stylus, laser readers, radio-frequency device readers, etc. Furthermore, the l/O devices 16 may also include output devices, for example but not limited to, a printer, bar code printers, displays, etc. Finally, the I/O devices 16 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11 is a PC, workstation, PDA, or the like, the software in the memory 14 may further include a basic input output system (BIOS) (not shown in FIG. 1). The BIOS is a set of software routines that initialize and test hardware at startup, start the O/S, and support the transfer of data among the hardware devices. The BIOS is stored in ROM so that the BIOS can be executed when the computer 11 is activated.

When the computer 11 is in operation, the processor 12 is configured to execute software stored within the memory 14, to communicate data to and from the memory 14, and to generally control operations of the computer 11 pursuant to the software. The management system 17 and the O/S, in whole or in part, but typically the latter, are read by the processor 12, perhaps buffered within the processor 12, and then executed.

When the management system 17 is implemented in software, as is shown in FIG. 1, it should be noted that the management system 17 can be stored on any computer readable medium for use by or in connection with any computer related system or method. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), a portable compact disc read-only memory (CDROM) (optical), a digital video disc (DVD), a universal serial bus (USB) drive, or other similar such memory devices. Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. The management system 17 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the management system 17 is implemented in hardware, the management system 17 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The management system 17 is software for managing a construction project. In general, the system permits users to budget the project and receive quotes. The system further permits designers to conduct initial customer interview, estimate and quote projects and tasks, prepare contracts, prepare an automated task list, track customer information and data, and communicate with customers, project managers, and showroom managers. The system permits project managers to plan projects, automate scheduling, price labor, communicate with customers, designers, and showroom managers. The system also permits showroom managers to allocate resources, determine job profitability, determine designer productivity, determine subcontractor performance, and determine customer satisfaction.

The management system 17 includes budgeting tools, allows a user to work with a designer to establish a budget, allows a user to determine their lifestyle requirements and translate them into a preliminary and finalized construction design. The system also includes a pre-qualification process to save designers time while aligning the customer's expectations with their budget and determine project time lines. Information captured during the sales process flows to the entire team: designers, project managers, subcontractors and installers, resulting in more efficient communications.

In one embodiment, the management system 17 receives a request to either create a new construction project track or open an existing construction project track. The construction project track identifies at least one project task required to complete the construction project. For example, a user may create a new construction project track to build a new kitchen in a house. In the example, the construction project track for the new kitchen will include a project task of installing new cabinets.

The system can then receive a budget criteria from the user. The budget criteria includes information on the amount of money a consumer wishes to spend on the construction project. This can include product costs and labor costs. The budget criteria can be a fixed dollar number or may be determined as a percentage of the cost of the entire house. Product costs can include the cost of physical products, while labor costs include the cost of labor to install the product. In addition, the customer may further break down the budget criteria in to the appropriate percentage of total costs that should be spent on labor and other allocations. Based on this information, the system determines budget information for each project task.

The budget information for each project task can include product budget information, labor budget information, markup costs, margin costs, and retail costs. In addition, the user may modify the budget information for any and all of the project tasks.

The user may then input product task information criterion. The product task information criterion includes criteria relating to a product the user wishes to use in the construction project. For example, the user may determine to use five 42-inch cherry wood cabinets with gold knob-handles. Based on this information, as well as the product budget criterion relating to this project task, the system determines product task information that is best suited to meet the customers needs. This information may be determined from a database coupled to the system, or by drawing data from a remote database such as, for example, the internet.

The system further correlates an indicator with at least one of the project tasks. The indicator can be construction project status, project task status, next action to be taken on a project task, construction project contract status or any other indicator relevant to such a project. This permits the user to see the timeframe for completing the entire project as well as individual tasks within the project.

The system may also be utilized by an administrator, manager, or contractor associated with a construction project. The system receives a user login representative of a user wherein the user login is associated with a category identifier. The category identifier may be one of an administrator, manager, or contractor associated with the construction project. Once a user login is inputted, the system displays a construction project track. The construction project track identifies at least one project task required to complete the construction project. For example, the project task information can be project type, project length, vendor information, sub-contractor work procedure information, product task information, project task budget information, region information, district information, store information, project class information, contractor information, payment information, or contract information. The system displays project task information for each project task based the category identifier.

In addition, the system can displaying user information corresponding to a user login and categorize the user login in a user group based on the category identifier. The system can also display anticipated project profit information.

As noted, one type of user may be a consumer. The system permits designers to work side-by-side with consumer, educating them on the design process, building a budget customized to their unique set of circumstances.

Another type of user may be a designer. The system permits designers to manage sales leads by automating follow up processes. Designers are provided with reports for proactive customer management. In addition, the system allows designers to build a budget side-by-side with a customer during the qualification process. Designers can build quotes quickly and accurately with the system providing a quote quicker, reducing sale cycle time, allowing your design team to close more sales in less time. In addition, the system allows quotes to be quickly turned into contracts. The contracts can be customized for allowing for site-specific information to be entered by the administrator to print on each contract. In addition, the system provides automated task lists provide designers with a specific view of what they need to be done at the present time.

Another type of user may be a project manager. The system permits project managers to view the automated task list captured during the sales process and make modifications if necessary. The system permits dynamic scheduling to eliminate the confusion of material ordering and delivery as well as helping control contractor scheduling. In addition, information is provided to managers and team members to see the status of each project. With the centralized job information, the need to search for missing documents and job requirements is eliminated, resulting in greater productivity. On-going status and delays are noted for all team members to see, allowing for a proactive approach to job management versus the common and reactive method to problems and breakdowns in the present state of the art.

The system provides the ability to manage all elements of labor pricing, which provides several benefits. Designers will write a more comprehensive scope of work, which reduces miscommunication with the customer. A more comprehensive scope of work results in fewer returns and allowances, which will increase overall job profitability. Frequently, labor items are omitted from quotes when priced manually. The system reduces mistakes from costly omissions.

The system allows contractor information to be organized and managed in one place, simplifying all aspects of contractor management. Expiration of contracts, certificates of insurance, etc. can be flagged at the appropriate time for follow up. Finally, each job can be quoted at the time of quote, so that the profitability of the job before quoting the customer can be determined, once again minimizing costly mistakes.

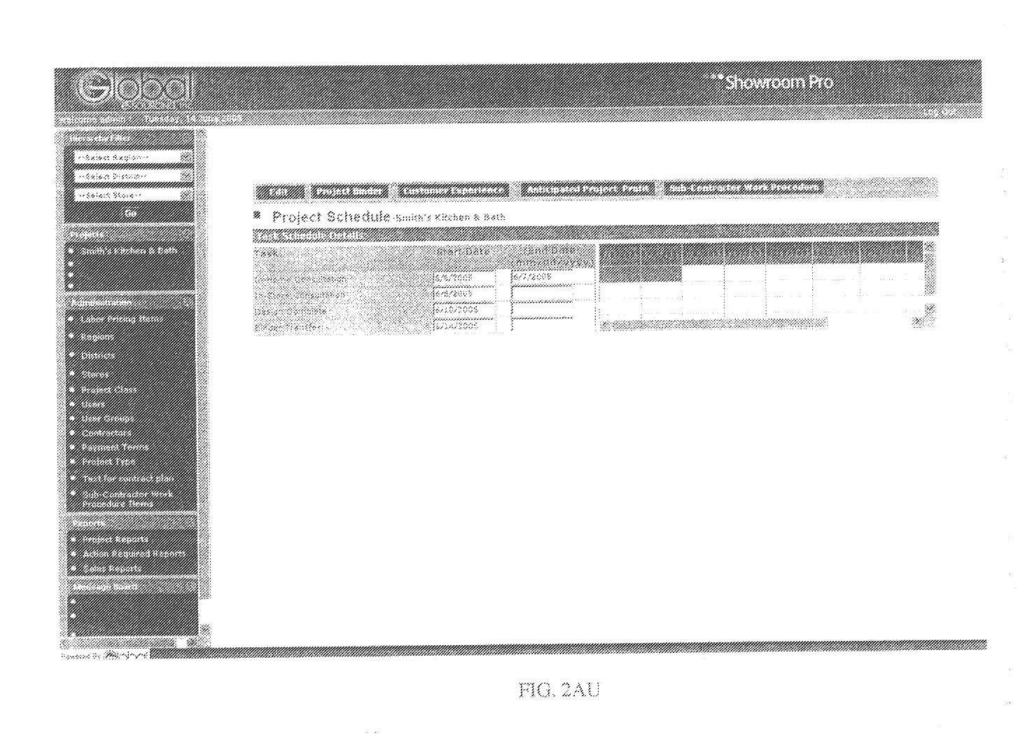

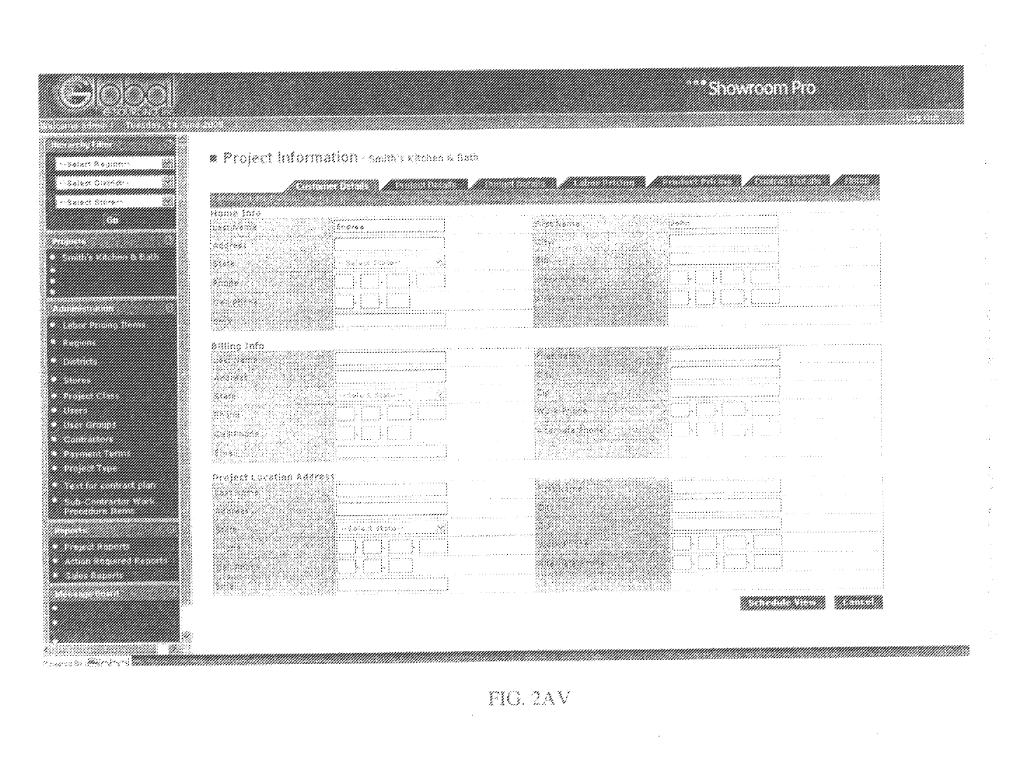

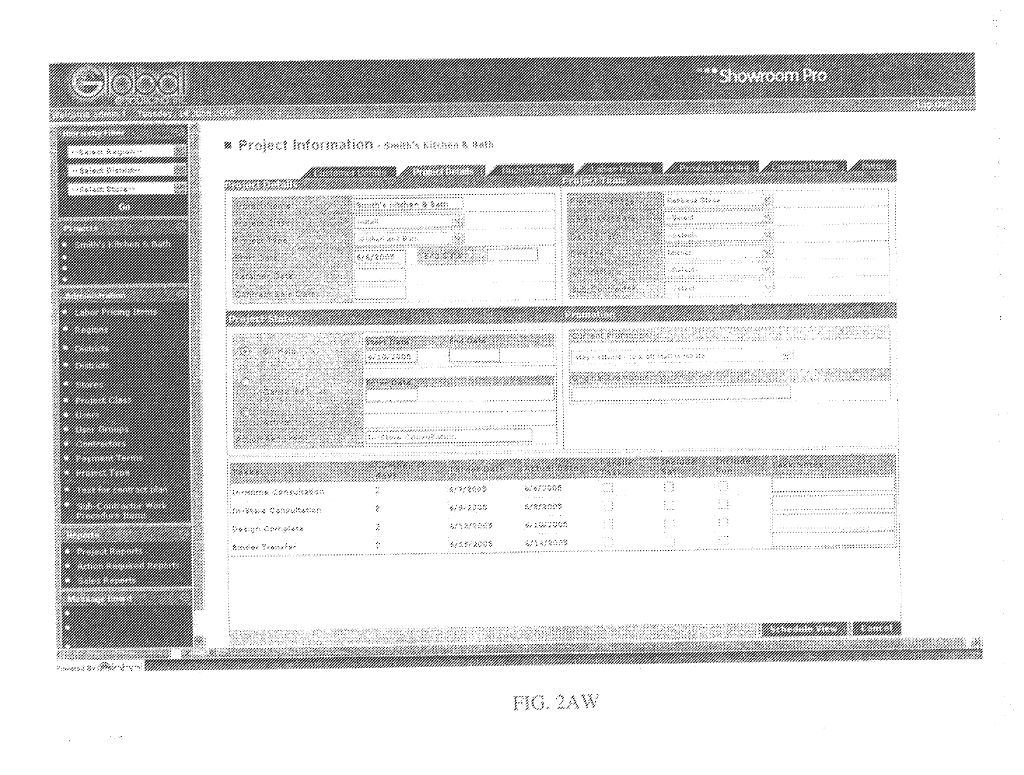

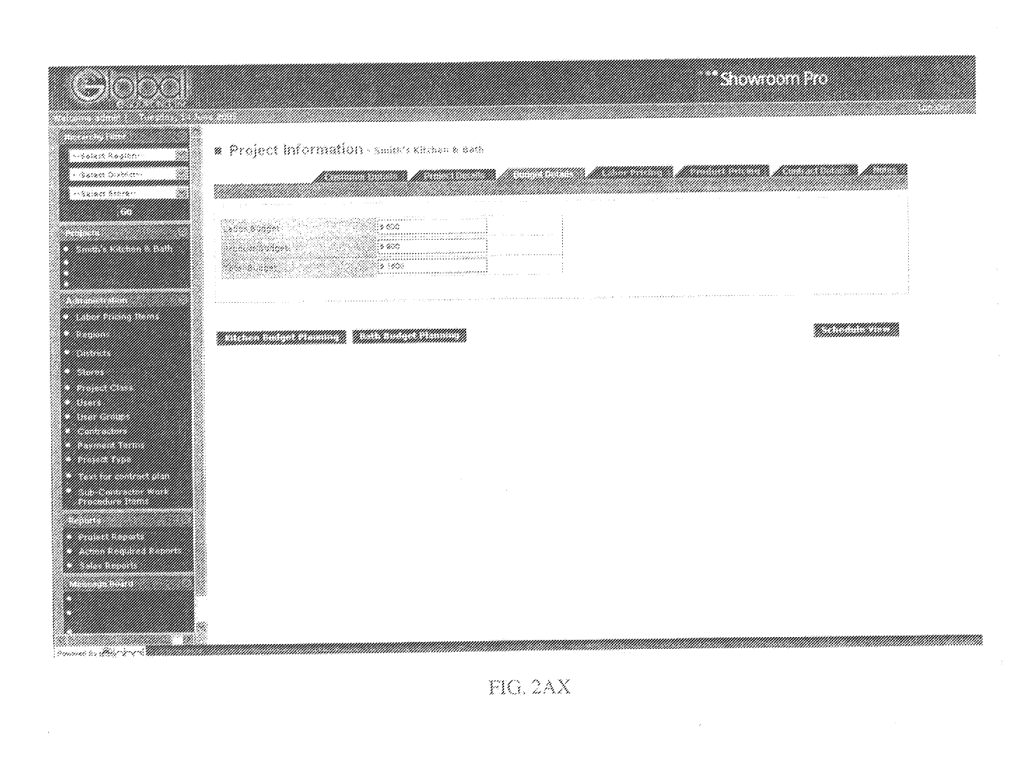

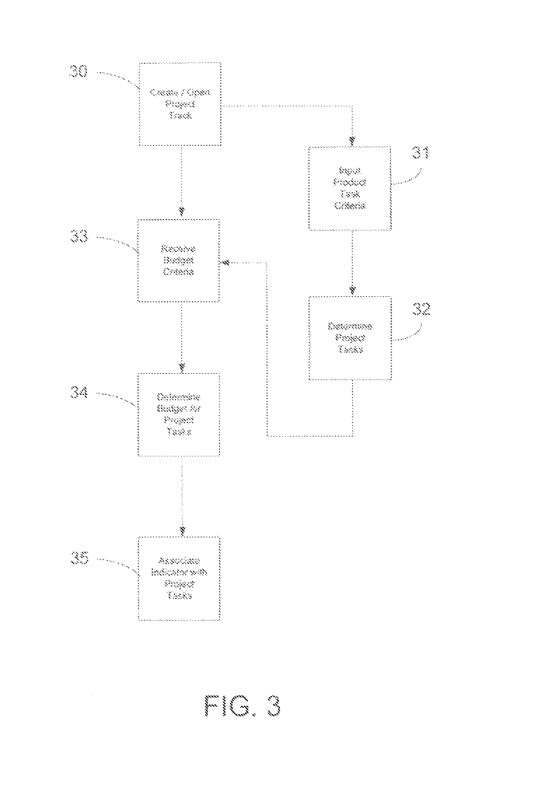

Referring now to FIG. 3, a flowchart for a system and method for managing kitchen and bath design projects is illustrated. Illustrated as step 30, the first step of the method is to receive a request to perform at least one of (a) creating a new construction project track and (b) opening an existing construction project track, wherein the construction project track identifies at least one project task required to complete a construction project. Illustrated as step 33, the second step of the method is to receive budget criteria. Illustrated as step 34, the final step of the method is to determine project task budget information for each of the project tasks based on the budget criteria.

In one embodiment, the budget information for each project task includes at least one of (a) product budget information, (b) labor budget information, (c) markup costs, (d) margin costs and (e) retail costs. In another preferred embodiment, the project task includes at least one of (a) product task information and (b) labor task information.

In one embodiment, illustrated as step 31, the method further comprises the step of inputting product task information criterion. That preferred embodiment also preferably comprises, illustrated as step 32, the step of determining product task information based on the product information criterion. In another preferred embodiment, illustrated as step 35, the method further includes the step of associating an indicator with at least one of the project tasks, wherein the indicator is at least one of (a) construction project status, (b) project task status, (c) next action to be taken on a project task and (d) construction project contract status.

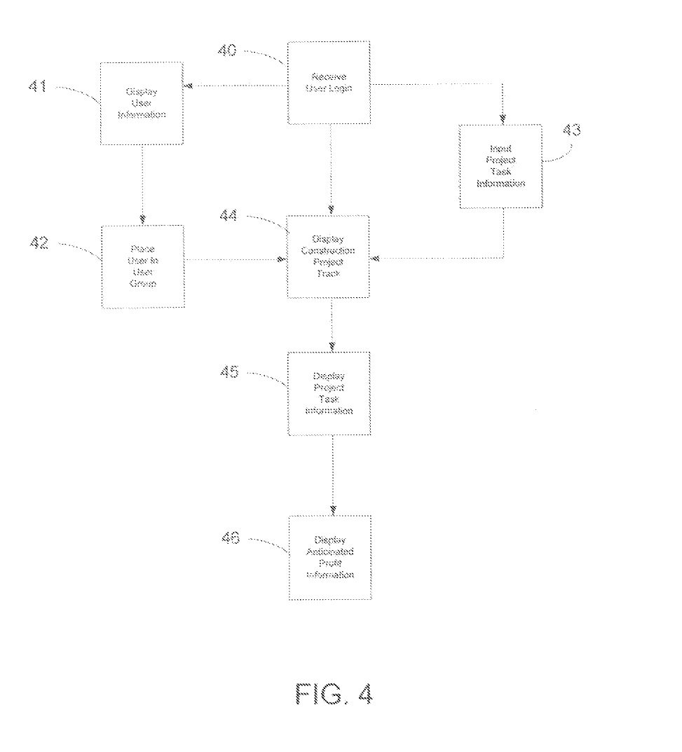

Referring now to FIG. 4, a flowchart for a system and method for managing kitchen and bath design projects is illustrated. Illustrated as step 40, the first step of the method is to receive a user login representative of a user, wherein the user login is associated with a category identifier. Illustrated as step 44, the next step of the method is to display a construction project track, wherein the construction project track identifies at least one project task required to complete the construction project. Illustrated as step 45, the last step of the method is to display project task information for at least one project task, wherein the project task is based on the category identifier.

In one embodiment illustrated as step 43, the method further comprises the step of inputting project task information, wherein the project task information is at least one of (a) a project type, (b) vending information, (c) sub-contractor work procedure information, (d) product task information, (e) project task budget information, (f) region information, (g) district information, (h) store information, (i) project class information, (j) contractor information, (k) payment information and (l) contract information. In another preferred embodiment illustrated as step 45, the method further comprises the step of displaying project task information, wherein the project task information is at least one of (a) through (l) types of information provided above.

In one embodiment illustrated as step 41, the method further comprises the step of displaying user information corresponding to the user login. In another preferred embodiment illustrated as step 42, the method further comprises the step of placing the user login in a user group based on the category identifier. In another preferred embodiment illustrated as step 46, the method further comprises the step of displaying anticipated project profit information. The invention further provides, as will be understood by one of skill in the art, an embodiment in which the method described herein is embodiment in a computer software program consisting of a plurality of code segments, wherein each of the plurality of code segments is configured to execute a step of the method described herein.

While the specific embodiments have been illustrated and described, numerous modifications come to mind without significantly departing from the spirit of the invention, and the scope of protection is only limited by the scope of the accompanying Claims.While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

What is claimed is:

1. A method for managing a construction project, the method comprising the steps of:
receiving a request to perform at least one of creating a new construction project track and opening an existing construction project track, wherein the construction project track identifies at least one project task required to complete a construction project;
receiving budget criteria; and
determining project task budget information for each project task based on the budget criteria.

2. The method of claim 1 wherein the budget information for each project task includes at least of one of product budget information, labor budget information, markup costs, margin costs, and retail costs.

3. The method of claim 1 wherein the project task includes at least one of product task information and labor task information.

4. The method of claim 1 further comprising the steps of:
inputting product task information criterion; and,
determining product task information based upon product information criterion.

5. The method of claim 1 further including a step of associating an indicator with at least one of the project tasks wherein the indicator is at least one of construction project status, project task status, next action to be taken on a project task, and construction project contract status.

6. A method for managing a construction project, the method comprising the steps of:
receiving a user login representative of a user wherein the user login is associated with a category identifier;
displaying a construction project track wherein the construction project track identifies at least one project task required to complete the construction project; and
displaying project task information for at least one project task, wherein the project task is based on the category identifier.

7. The method of claim 6 comprising the step of inputting project task information wherein the project task information is at least one of a project type, vendor information, sub-contractor work procedure information, product task information, project task budget information, region information, district information, store information, project class information, contractor information, payment information, and contract information.

8. The method of claim 6 comprising the step of displaying project task information wherein the project task information is at least one of a project type, vendor information, sub-contractor work procedure information, product information, project task budget information, region information, district information, store information, project class information, contractor information, payment information, and contract information.

9. The method of claim 6 comprising the step of displaying user information corresponding to the user login.

10. The method of claim 6 comprising the step of placing the user login in a user group based on the category identifier.

11. The method of claim 6 comprising the step of displaying anticipated project profit information.

12. A computer program for managing a construction project, the computer program being embodied on a computer readable storage medium adapted to control a computer, the computer program comprising:
a code segment for receiving a request to perform at least one of creating a new construction project track and opening an existing construction project track, wherein the construction project track identifies at least one project task required to complete the construction project;
a code segment for receiving budget criteria; and
a code segment for determining project task budget information for each project task based on the budget criteria.

13. The computer program of claim 12 wherein the budget information for each project task includes at least of one of product budget information, labor budget information, markup costs, margin costs, and retail costs.

14. The computer program of claim 12 wherein the project task includes identifies at least one of product task information and labor task information.

15. The computer program of claim 12 further comprising:
a code segment for inputting product task information criterion; and,
a code segment for determining product task information based upon product information criterion.

16. The computer program of claim 12 further including a code segment for correlating an indicator with at least one of the project tasks wherein the indicator is at least one of construction project status, project task status, next action to be taken on a project task, and construction project contract status.

17. A computer program for managing a construction project comprising:
a code segment for receiving a user login representative of a user wherein the user login is correlated with a category identifier;
a code segment for displaying a construction project track wherein the construction project track identifies at least one project task required to complete the construction project; and
a code segment for displaying project task information for each project task based the category identifier.

18. The computer program of claim 17 comprising a code segment for inputting project task information wherein the project task information is at least one of project type, vendor information, sub-contractor work procedure information, product task information, project task budget information, region information, district information, store information, project class information, contractor information, payment information, and contract information.

19. The computer program of claim 17 comprising a code segment for displaying project task information wherein the project task information is at least one of project type, vendor information, sub-contractor work procedure information, product information, project task budget information, region information, district information, store information, project class information, contractor information, payment information, and contract information.

20. The computer program of claim 17 comprising a code segment for displaying user information corresponding to the user login.

21. The computer program of claim 17 comprising a code segment for placing the user login in a user group based on the category identifier.

22. The computer program of claim 17 comprising a code segment for displaying anticipated project profit information.
